(19) United States
(12) Patent Application Publication
(10) Pub. No.: US 2008/0002949 A1
(43) Pub. Date: Jan. 3, 2008

(54) Recording system and recording method

(76) Inventors: Junzo Tokunaka, Kanagawa (JP); Mitsutoshi Shinkai, Kanagawa (JP)

Correspondence Address: FROMMER LAWRENCE & HAUG LLP, 745 FIFTH AVENUE, NEW YORK, NY, 10151, US

(21) Appl. No.: 11/810,397

(22) Filed: Jun. 5, 2007

(30) Foreign Application Priority Data
Jun. 7, 2006 (JP) 2006-158177

(51) Int. Cl. H04N 5/91

(52) U.S. Cl. 386/96

(57) ABSTRACT

A recording system includes an input unit that inputs text data, a read-out time calculating unit that calculates a read-out time length for text data on the basis of information on a predetermined read-out speed, a read-out data generating unit that generates, on the basis of the information on the predetermined read-out speed, a text time code indicating read-out timing for each predetermined number of characters in the text data and generates read-out data obtained by attaching this text time code to the text data, and a control unit that controls, according to an instruction, audio data based on an input sound to be recorded in a recording medium and controls, on the basis of the read-out data, characters based on the text data displayed on a display unit to be intend-displayed.

### CROSS-REFERENCES TO RELATED APPLICATIONS

The present invention contains subject matter related to Japanese Patent Application JP 2006-158177 filed in the Japanese Patent Office on Jun. 7, 2006, the entire contents of which being incorporated herein by reference.

### BACKGROUND OF THE INVENTION

1. Field of the Invention

The present invention relates to a recoding system and a recording method suitably applied to, in particular, systems that record a narration sound, which should be read out within a predetermined time, such as a video and sound editing system for business use.

2. Description of the Related Art

For example, in some news programs and the like in television broadcasts, news contents with a narration sound as a news script inserted in a video obtained by photographing scenes of incidents and accidents are broadcasted.

In production of news contents of this type, for example, a reporter and a cameraman proceed to the scene. In this case, not only photographing of a video of the scene but also insertion of a narration sound of a news script may be performed on the scene. In other words, even production of news contents is performed on the scene.

In general, in production of news contents, it is often determined at the stage before coverage what kinds of contents are reported in how long a time frame. Therefore, the reporter, the cameraman, and the like on the scene photograph videos and create a narration script according to such a coverage plan.

The reporter, the cameraman, and the like perform production of the news contents on the scene using, for example, a portable editing apparatus. The reporter, the cameraman, and the like input photographed videos to such editing apparatus, read out the script created as described above to record a narration sound, and, then, combine a video and a sound to produce news contents.

### SUMMARY OF THE INVENTION

When news contents are produced to fit in a predetermined time frame set in advance as described above, a video and a narration sound forming the news contents also need to be generated to fit in the time frame. In other words, concerning the video, it is necessary to edit photographed videos (material videos) to fit in a predetermined time. Concerning the narration sound, it is necessary to read out a script within the time.

It is relatively easy for a specialist such as a newscaster to read out a narration within the time as described above. However, when it is assumed that the narration is inputted on the scene as described above, the reporter, the cameraman, and the like need to input the narration. This is considered to be extremely difficult.

Consequently, it is demanded that, in particular, an editing apparatus that is carried to a scene and used for producing news contents should allow even people who are not accustomed to read-out of a script such as a reporter and a cameraman to easily read out the script within a set time.

Therefore, it is desirable to provide a recording system described below.

According to an embodiment of the invention, there is provided a recording system including an input unit that inputs text data, a read-out time calculating unit that calculates a read-out time length for text data on the basis of information on a predetermined read-out speed, a read-out data generating unit that generates, on the basis of the information on the predetermined read-out speed, a text time code indicating read-out timing for each predetermined number of characters in the text data and generates read-out data obtained by attaching this text time code to the text data, and a control unit that controls, according to an instruction, audio data based on an input sound to be recorded in a recording medium and controls, on the basis of the read-out data, characters based on the text data displayed on a display unit to be intend-displayed.

According to the embodiment, since a read-out time is calculated for inputted text data (an inputted script), a user can check whether it is possible to finish reading out the inputted script within a time limit when the user reads out the script at a predetermined read-out speed. When a narration based on the inputted script is recorded, positions of characters that should be read are intend-displayed on the basis of text time codes generated on the basis of information on the predetermined read-out speed. Consequently, a present read-out position of the inputted script is indicated on a real time basis when the script is read out at the predetermined read-out speed.

According to the embodiment, the user can easily read out the inputted script within a predetermined time limit by reading out displayed characters in accordance with intend positions. As a result, it is possible to support the user to allow the user to easily read out the inputted script within a set time.

### BRIEF DESCRIPTION OF THE DRAWINGS

FIG. 1 is a diagram for explaining a general configuration of a recording system according to an embodiment of the invention;

FIG. 2 is a block diagram showing an internal structure of an editing apparatus that constitutes the recording system according to the embodiment;

FIG. 3 is a block diagram showing an internal structure of a personal computer that constitutes the recording system according to the embodiment;

FIG. 4 is a diagram for explaining operations of a recording system according to a first embodiment of the invention and, in particular, schematically showing operations from input of text data as a news script to generation of read-out data;

FIG. 5 is a diagram showing an example of a recording screen that should be displayed in association with the time of a recording support operation (and preview play after recording) performed by the recording system according to the first embodiment;

FIG. 6 is a diagram showing an example of a screen that should be displayed in association with the time of the recording support operation (and the preview play after recording) performed by the recording system according to the first embodiment;

FIG. 7 is a diagram showing an example of a screen that should be displayed in association with the time of the recording support operation (and the preview play after recording) performed by the recording system according to the first embodiment;

FIG. 8 is a diagram showing an example of a screen that should be displayed in association with the time of the recording support operation (and the preview play after recording) performed by the recording system according to the first embodiment;

FIGS. 9A to 9C are diagrams showing examples of a screen that should be displayed in association with the time of acceptance of correction of a recorded sound;

FIGS. 10A and 10B are diagrams showing examples of a portion designating screen that should be displayed in association with the time of designation of a correction portion of the recorded sound in the recording system according to the first embodiment;

FIGS. 11A and 11B are diagrams showing examples of a sound/video combination screen that should be displayed in association with the time of combination of the recorded sound and an edited video in the recording system according to the first embodiment;

FIG. 12 is a diagram showing an example of a screen that should be displayed in association with the time of preview play after combination of a sound and a video in the first embodiment (and during a recording support operation and during preview play after recording in a second embodiment of the invention);

FIG. 13 is a diagram showing an example of a screen that should be displayed in association with the time of the preview play after combination of a sound and a video in the first embodiment (and during the recording support operation and during the preview play after recording in the second embodiment);

FIG. 14 is a diagram showing an example of a screen that should be displayed in association with the time of the preview play after combination of a sound and a video in the first embodiment (and during the recording support operation and during the preview play after recording in the second embodiment);

FIG. 15 is a flowchart showing processing operations that should be performed to realize operations of the recording system according to the first embodiment and mainly showing processing operations that should be performed in association with the time of operations from input of a time limit and text data to generation of read-out data;

FIG. 16 is a flowchart showing the processing operations that should be performed to realize the operations of the recording system according to the first embodiment and mainly showing processing operations that should be performed in association with the time of a recording support operation;

FIG. 17 is a flowchart showing the processing operations that should be performed to realize the operations of the recording system according to the first embodiment and mainly showing processing operations that should be performed in association with the time of a recorded sound correction operation;

FIG. 18 is a flowchart showing the processing operations that should be performed to realize the operations of the recording system according to the first embodiment and mainly showing processing operations that should be performed in association with the time of processing for combining a sound and a video;

FIG. 19 is a diagram schematically showing operations performed in a recording system according to the second embodiment;

FIG. 20 is a conceptual diagram of a portion designating operation according to the second embodiment;

FIGS. 21A and 21B are diagrams showing examples of a video/text portion designating screen that should be displayed in association with the time of the portion designating operation according to the second embodiment;

FIG. 22 is a flowchart showing processing operations that should be performed to realize operations of the recording system according to the second embodiment and mainly showing processing operations that should be performed in association with the time of generation of read-out data from input of text data;

FIG. 23 is a flowchart showing the processing operations that should be performed to realize the operations of the recording system according to the second embodiment and mainly showing processing operations that should be performed in association with the time of the portion designating operation;

FIG. 24 is a flowchart showing the processing operations that should be performed to realize the operations of the recording system according to the second embodiment and mainly showing processing operations that should be performed in association with operations from a recording support operation to an operation for writing a combined file of a sound and a video in a disk; and

FIG. 25 is a flowchart showing the processing operations that should be performed to realize the operations of the recording system according to the second embodiment and mainly showing processing operations that should be performed in association with the time of recorded sound correction operation.

### DESCRIPTION OF THE PREFERRED EMBODIMENTS

Best modes for carrying out the invention (hereinafter, referred to as “embodiments”) will be hereinafter explained.

[Schematic System Configuration]

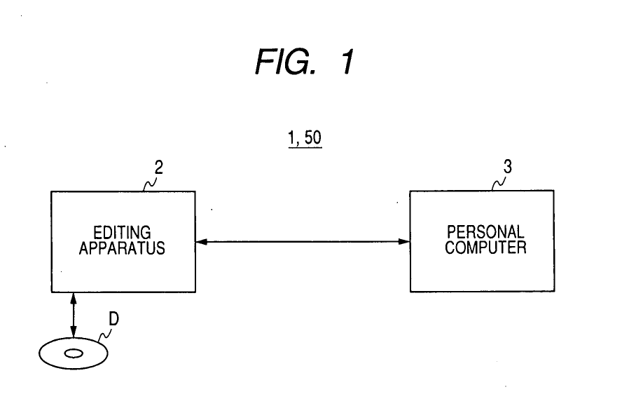

FIG. 1 is a diagram for explaining a schematic configuration of a recording system according to an embodiment of the invention (an editing system 1 according to a first embodiment of the invention and an editing system 50 according to a second embodiment of the invention).

As shown in the figure, the editing systems 1 and 50 according to the embodiment include at least an editing apparatus 2 and a personal computer 3.

The editing apparatus 2 is a portable editing apparatus for business use that is manufactured on the assumption that the editing apparatus is used by television broadcasters, program producers, and the like for edition of photographed videos and input sounds in scenes and the like.

The editing apparatus 2 performs edition and the like of video and audio data recorded in an optical disk recording medium as an optical disk D shown in the figure such as a DVD (Digital Versatile Disc) or a Blu-ray Disc (Blu-ray: registered trademark). The editing apparatus 2 can also record edited video and audio data in the optical disk D.

As the personal computer 3, a general personal computer is assumed. In this case, since it is assumed that the personal computer 3 is used outdoors on a scene of coverage or the like together with the editing apparatus 2, the personal computer 3 is a notebook personal computer.

In this embodiment, the personal computer 3 functions mainly as a text input apparatus for inputting a narration script.

[Structure of the Editing Apparatus]

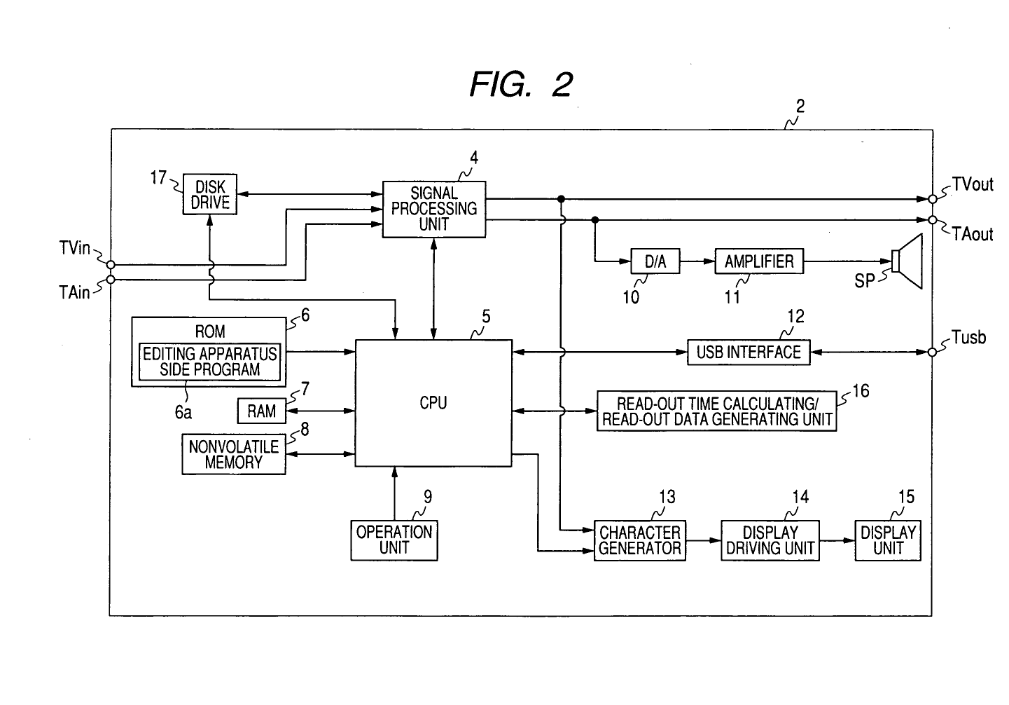

FIG. 2 is a block diagram showing an internal structure of the editing apparatus 2 shown in FIG. 1.

In FIG. 2, as the internal structure of the editing apparatus 2, only sections necessary for performing operations according to the embodiment described later are extracted. Other sections are omitted.

In FIG. 2, a disk drive 17 for performing actual operations for recording data in and reproducing the data from the optical disk D shown in FIG. 1 is provided in the editing apparatus 2.

In the optical disk D associated with the editing apparatus 2 according to the embodiment, recording and reproduction at, for example, a laser wavelength λ=405 nm and NA (numerical apertures)=0.65 are performed. A recording film is formed to have a phase change film and is capable of rewriting data.

A recording capacity is relatively large at about several tens GB (gigabyte). Consequently, as a business use, it possible to cope with videos of high resolution.

In this case, it is assumed that, in particular, video data photographed and recorded by an external camera apparatus is stored in the optical disk D. In this embodiment, since a business application is assumed, a time code (a video time code) is attached to the video data for each of frame images thereof. Therefore, it is possible to manage a position on a time axis of the frame image according to this video time code.

The disk drive 17 includes, as components for performing recording and reproduction of data recorded in the optical disk D inserted therein, an optical head, a spindle motor, a servo circuit, a decoder for obtaining reproduced data, and an encoder for recording data generation.

Video data reproduced from the optical disk D by the disk drive 17 is supplied to a signal processing unit 4 shown in the figure. Video data that should be recorded in the optical disk D is inputted to the disk drive 17 from the signal processing unit 4.

The signal processing unit 4 can perform various kinds of video signal processing for video data and various kinds of audio signal processing for audio data.

It is also possible to input video data to the signal processing unit 4 from a video input terminal TVin shown in the figure. This makes it possible to directly input video data photographed by, for example, an external camera apparatus.

In particular, the editing apparatus 2 according to this embodiment is capable of recording audio signal inputted from an audio input terminal TAin shown in the figure. For the recording, the signal processing unit 4 includes a micro-amplifier that performs amplification processing for the audio signal inputted from the audio input terminal TAin and an A/D converter (not shown).

The signal processing unit 4 supplies, according to a recording start instruction from a CPU (Central Processing Unit) 5 described later, audio data based on an input from the audio input terminal TAin to the CPU 5. The CPU 5 records the audio data inputted in a nonvolatile memory 8.

The signal processing unit 4 is capable of also performing edition processing for slicing a part of video data, which are material videos, to generate a video clip on the basis of an instruction from the CPU 5 and joining plural video clips to generate a series of video data and combination processing for combining audio data with the video data to generate an AV (Audio Visual) data file (hereinafter simply referred to as “AV file” as well).

Moreover, the signal processing unit 4 in this case is capable of also performing compression/expansion processing in a time axis direction (time axis compression/expansion processing) for audio data. The signal processing unit 4 applies, on the basis of information on a time length indicated by the CPU 5, the time axis compression/expansion processing to object audio data such that a time length of the audio data becomes equal to the time length indicated.

As shown in the figure, a video output terminal TVout and an audio output terminal TAout are connected to the signal processing unit 4. This makes it possible to output video data and audio data to the outside.

The video data supplied to the video output terminal TVout is divided and also supplied to a character generator 13 described later.

Moreover, the audio data supplied to the audio output terminal TAout is divided and also supplied to a D/A converter 10 shown in the figure. The audio data supplied to the D/A converter 10 is D/A converted, amplified by an amplifier 11 shown in the figure, and, then, outputted by a speaker SP.

The character generator 13 generates character data such as characters (including numerals and signs) and icons.

The character generator 13 can generate display data obtained by combining the video data and the character data from the signal processing unit 4. Alternatively, the character generator 13 can generate display data such that only characters are displayed. Moreover, the character generator 13 can also directly output the video data from the signal processing unit 4 without superimposing characters on the video data.

The character generator 13 performs switching of the operations on the basis of an instruction from the CPU 5.

Output data from the character generator 13 is supplied to a display driving unit 14.

The display driving unit 14 drives a display unit 15 such as a liquid crystal display on the basis of input data from the character generator 13. Consequently, image display based on an output from the character generator 13 is performed on the display unit 15.

The CPU 5 performs overall control of the editing apparatus 2 and arithmetic processing on the basis of a booted-up program. The CPU 5 controls, for example, an operation corresponding to an operation input from an operation unit 9 shown in the figure, operations for recording data in and reproducing the data from the optical disk D inserted in the disk drive 17, and an operation for accessing the optical disk D.

In particular, in the case of this embodiment, the CPU 5 performs time count from a recording start point during recording based on an input sound from the audio input terminal TAin. The CPU 5 also performs an operation for attaching a audio time code to audio data on the basis of a count value of the time count.

In association with the CPU 5, as shown in the figure, a ROM (Read Only Memory) 6, a RAM (Random Access Memory) 7, and a nonvolatile memory 8 are provided.

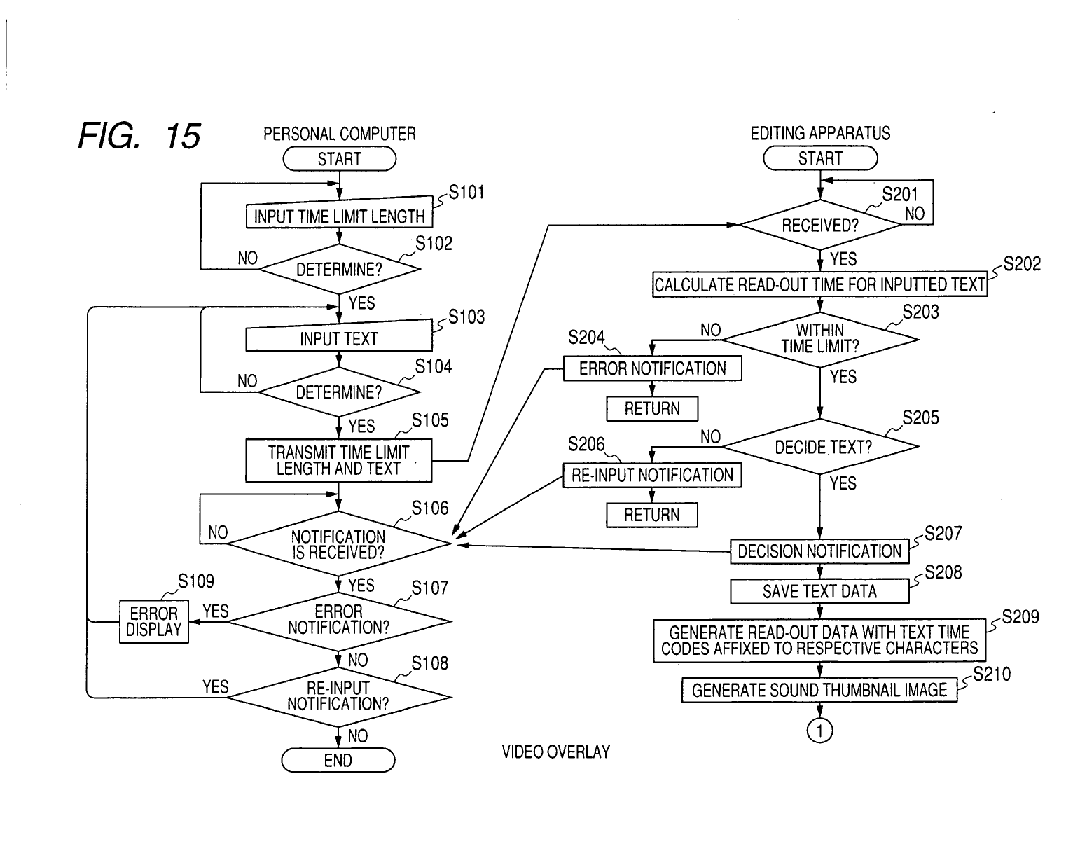

In the ROM 6, an operation program for the CPU 5, a program loader, and the like are stored. In particular, in the case of this embodiment, an editing apparatus side program 6a for causing the CPU 5 to execute processing operations (FIGS. 15 to 18 or FIGS. 22 to 25) for realizing operations in the embodiments described later is also stored in the ROM 6.

In the RAM 7, a data area and a task area used by the CPU 5 in executing programs are temporarily secured.

The nonvolatile memory 8 is a nonvolatile memory in which data is rewritable and recorded data is held even after a power supply is turned off. For example, various arithmetic coefficients and parameters used in the programs are stored in the nonvolatile memory 8. In particular, in the case of this embodiment, recorded audio data based on an input from the audio input terminal TAin and information such as a text time code described later are also stored in the nonvolatile memory 8.

The operation unit 9 includes various operators provided on a surface of a housing of the editing apparatus 2. As the operators included in the operation unit 9, a cross key for direction instruction, a determination key for determining various items, a search dial used in various kinds of operation for volume adjustment and numerical adjustment, and the like are provided. The operation unit 9 supplies operation information (an operation signal) for each of the operators to the CPU 5. The CPU 5 executes a processing operation corresponding to the operation information from the operation unit 9. An operation corresponding to an instruction of a user is realized by the processing operation.

In order to perform data communication with an external apparatus (in particular, in this case, the personal computer 3 shown in FIG. 1) connected the editing apparatus 2 via a USB cable connected to a USB terminal Tusb shown in the figure, a USB (Universal Serial Bus) interface 12 is provided. In particular, exchange of various data such as text data and commands inputted on the personal computer 3 is performed as described later via the USB interface 12 in this case.

The editing apparatus 2 according to this embodiment includes a read-out time calculating/read-out data generating unit 16 shown in the figure. The read-out time calculating/read-out data generating unit 16 calculates, concerning a character string based on text data inputted from the CPU 5, a time length of read-out of the character string at a predetermined read-out speed. Further, the read-out time calculating/read-out data generating unit 16 adds to the text data a text time code for indicating a read-out position of the character string based on the text data in reading out the character string at the predetermined read-out speed and generates read-out data.

In this case, as a method of calculating a read-out time length, for example, concerning a character such as a hiragana or katakana that is pronounced as one speech word, the character is multiplied by a predetermined coefficient representing a read-out time length for one word, which is the predetermined read-out speed. However, concerning a character such as a Chinese character that is not pronounced as one speech word, the number of speech words of the character is multiplied by the predetermined coefficient to calculate a time length necessary for read-out of the character.

In this way, a total read-out time length of the inputted text data is calculated.

A text time code for each of characters is attached to the read-out data in the same manner according to the number of speech words of a character such as a hiragana character, a katakana character, or a Chinese character forming the text data.

In calculating a read-out time according to the method and attaching a text time code for each of the characters, it is necessary to obtain information on the number of speech words for each of the characters of the text data. Therefore, for example, table information in which the number of speech words is stored for each of characters estimated as text data in advance is stored in the read-out time calculating/read-out data generating unit 16. The information on the number of speech words for each of the characters of the inputted text data is obtained with reference to this table information.

The “characters” in this context include, other than the hiragana and katakana characters and the Chinese character, characters other than the Japanese such as the English alphabet and the Korean alphabet, numerals, signs, and the like.

Information on the read-out time length calculated by the read-out time calculating/read-out data generating unit 16 is supplied to the CPU 5. The read-out data generated by the read-out time calculating/read-out data generating unit 16 is also supplied to the CPU 5.

In FIG. 2, the USB interface 12 is adopted as a communication interface for performing data communication between the editing apparatus 2 and the external apparatus (in particular, the personal computer 3 described later). As such a communication interface between the editing apparatus 2 and the personal computer 3, it is also possible to adopt other interfaces such as an IEEE (the Institute of Electrical and Electronic Engineers) 1394 interface. Alternatively, other than communication by wire, it is possible to perform the data communication with radio communication such as Bluetooth (registered trademark).

[Structure of a Personal Computer]

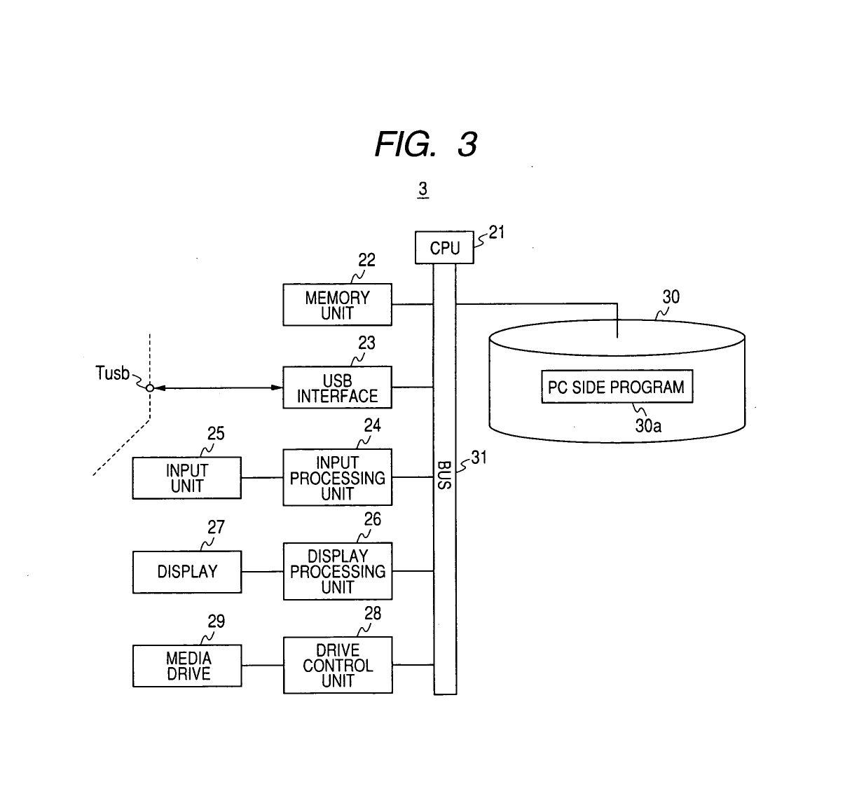

FIG. 3 is a block diagram showing an internal structure of the personal computer 3 shown in FIG. 1.

In FIG. 3, a CPU 21 performs control of the entire personal computer 3 and arithmetic processing on the basis of a booted-up program. The personal computer 3 performs, for example, operations for input from and output to a user, storage of a data file in a hard disk (HDD) 30, and creation and update of management information.

The CPU 21 performs exchange of control signals and data with respective units via a bus 31 shown in the figure.

A memory unit 22 collectively represents a ROM, a RAM, a flash memory, and the like used for processing by the CPU 21.

In the ROM in the memory unit 22, an operation program for the CPU 21, a program loader, and the like are stored. In the flash memory in the memory unit 22, various arithmetic coefficients, parameters used in programs, and the like are stored.

Moreover, in the RAM in the memory unit 22, a data area and a task area in executing the programs are temporarily secured.

In order to perform data communication with an external apparatus (in this case, the editing apparatus 2) connected to the personal computer 3 via a USB cable connected to a USB terminal Tusb shown in the figure, a USB interface 23 is provided.

In the HDD 30, storage of a data file, creation and update of management information, and the like are performed on the basis of the control by the CPU 21 as described above. For example, it is possible to store data captured from a necessary medium by a media drive 29 described later in the HDD 30.

It is also possible to store programs (applications) used by the personal computer 3 to realize various functions in the HDD 30. In particular, in the case of this embodiment, a PC side program 30a for causing the CPU 21 to execute processing operations (FIG. 15 or FIGS. 22 to 23) for realizing operations in the embodiments described later is stored in the HDD 30.

An input unit 25 is an input device such as a not-shown keyboard, mouse, or remote commander provided in the personal computer 3. The user performs various kinds of operation input and data input using the input unit 25. Information inputted by the input unit 25 is subjected to predetermined processing by an input processing unit 24 and transmitted to the CPU 21 as input of operation or data. The CPU 21 performs a necessary arithmetic operation and control according to the information inputted.

The media drive 29 is a drive function unit that copes with optical disks such as a CD, an MD (Mini Disc: a magneto-optical disk), a CR-R (Recordable), a CD-RW (ReWritable), a DVD (Digital Versatile Disc), a DVD-R, a DVD-RW, and a Blu-ray Disc or recording media such as a memory card (a semiconductor memory device as a removable medium). The media drive 29 is capable of performing operations for recording data in and reproducing the data from for these media. For example, when the media drive 29 handles an optical disk as a medium, the media drive 29 includes an optical head, a spindle motor, a reproduction signal processing unit, and a servo circuit.

A drive control unit 28 controls operations for recording data in and reproducing the data from a medium inserted in the media drive 29, an operation for accessing the medium, and the like. For example, when the user performs operation for playing the inserted medium via the input unit 25, the CPU 21 instructs the drive control unit 28 to play the medium. Then, the drive control unit 28 performs control for causing the media drive 29 to execute an operation for accessing the medium and an operation for reproducing data from the medium. The media drive 29 transmits the reproduced data to the bus 31 via the drive control unit 28.

A display 27 is a display device such as a liquid crystal panel and performs various kinds of information display for the user.

For example, when the CPU 21 supplies display information to a display processing unit 26 according to various operation state, inputs states, or communication states, the display processing unit 26 drives the display 27 on the basis of display data supplied to cause the display 27 to execute a display operation.

When video data is reproduced from a medium inserted in the media drive 29 or from the HDD 30, the display processing unit 26 drives the display 27 on the basis of this reproduced data to cause the display 27 to perform video display.

### Prerequisite Explanation of Embodiments

A reporter, a cameraman, or the like, who is assumed to be the user in this case, combines an edited video obtained by editing photographed videos and a narration sound to produce news contents using the editing system including the editing apparatus 2 and the personal computer 3 explained above.

Under the present situation, a procedure up to the production of news contents is roughly divided into two methods.

One of the methods is a method of performing recording of a narration sound in advance on the basis of a news script created on the basis of a coverage plan set in advance, performing photographing and edition of material videos to generate an edited video and, then, combining the narration sound and the edited video to produce news contents. The method of recording a narration first and combining an edited video with the narration in this way is called Video Overlay.

The other method is a method of photographing scene videos to obtain material videos, editing the material videos to obtain an edited video, and, then, combining a narration sound obtained by reading out a news script with the edited video. The method of combining a narration sound with an edited video later (i.e., performing postrecording) is called Voice Over.

The editing system according to the embodiment supports the user when the user reads out a news script and records a narration sound in the cases of both the Video Overlay and the Voice Over.

In the following explanation, first, an operation of the editing system 1 according to the first embodiment corresponding to the case in which news contents are produced according to the Video Overlay will be explained.

### First Embodiment

### Operations According to the First Embodiment

FIG. 4 is a diagram schematically showing operations of the recording system 1 according to the first embodiment and, in particular, schematically showing operations from input of text data as a news script to generation of read-out data.

In FIG. 4, in the editing system 1 according to the first embodiment, first, as indicated by <1> in the figure, on the personal computer 3 side, operations for inputting text data and a time limit are performed. Specifically, screen display for inputting the text data and the time limit on the display 27 shown in FIG. 3 is performed. A user uses the mouse and the keyboard provided as the input unit 25 to input the text data and the time limit to the screen.

In this case, as the time limit, the user inputs a time limit length in reading out a narration. Usually, since a read-out time length for the narration is determined by a coverage plan, the user inputs the time length.

On the personal computer 3 side, information on the text data and the time limit length inputted in this way are transmitted to the editing apparatus 2 connected to the personal computer 3 via the USB cable (<2> in the figure).

When the information on the text data and the time limit length from the personal computer 3 side is received, in the editing apparatus 2 side, first, calculation of a read-out time is performed as indicated by <3> in the figure. Specifically, a read-out time length for the received text data is calculated by the read-out time calculating/read-out data generating unit 16 shown in FIG. 2.

When the read-out time is calculated, for example, the CPU 5 judges whether a time length of the read-out time is within a range of the received time limit length (<4> in the figure).

When it is judged that the time length exceeds the time limit, the CPU 5 instructs the personal computer 3 side to correct the text data (<5> in the figure).

According to this correction instruction, on the personal computer 3 side, as shown in <6>, an operation for correcting the text data and, then, transmitting the text data to the editing apparatus 2 again is performed. Specifically, after an error message such as “the time limit is over” is displayed on the display 27, correction operation for the text data inputted is accepted. When operation for deciding (determining) the text data after the correction is performed, the text data after the correction is transmitted to the editing apparatus 2 again.

When the text data transmitted again from the personal computer 3 side in this way is received, on the editing apparatus 2 side, as in the above <3> and <4>, it is judged whether a read-out time for the text data is within the time limit. When the read-out time is not within the time limit, the operation in <5> is performed in the same manner. The correction of the text data is repeated until a read-out time fits in the time limit.

On the other hand, when the text data received is within the time limit, as indicated by <7>, read-out data according to an instruction is generated. Specifically, the read-out time calculating/read-out data generating unit 16 attaches a text time code based on a predetermined read-out speed set in advance to each of characters of the text data received to generate read-out data.

Here, in the editing system 1 according to this embodiment, an operation for supporting recording of a narration sound is performed on the basis of the read-out data generated in this way.

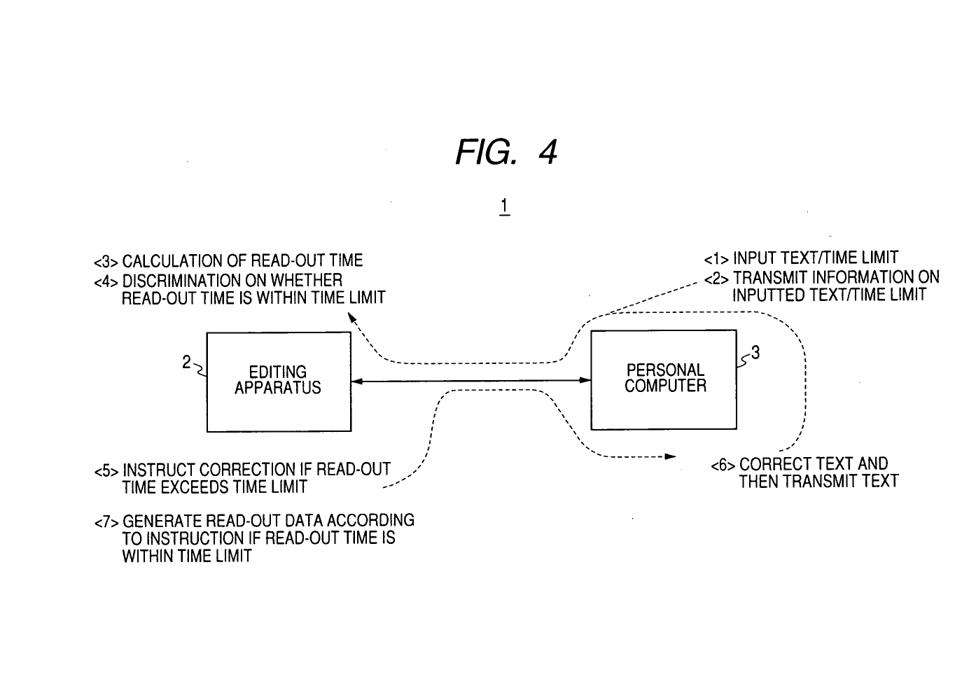

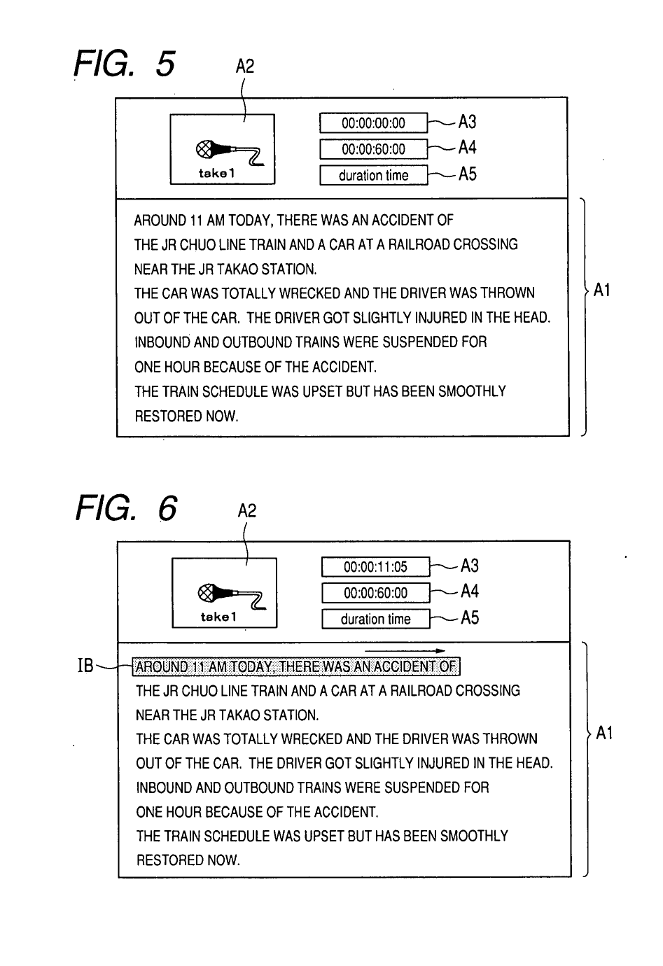

Such a recording support operation will be hereinafter explained with reference to FIGS. 5 to 8.

FIGS. 5 to 8 show examples of screens displayed on the display unit 15 in association with the time of such a recording support operation.

First, in FIG. 5, a state of a recording screen before recording is started is shown. In this recording screen, as shown in the figure, a text display area A1, a sub-screen area A2, a text time code display area A3, a time limit display area A4, and a duration time display area A5 are provided.

The text display area A1 is an area for displaying contents of the text data inputted by the personal computer 3 and received on the editing apparatus 2 side. In the text display area A1, when all characters of the inputted text are not fully displayed, characters that can be displayed are displayed. In that case, it is possible to sequentially display the following character strings by performing scroll as described later.

The sub-screen area A2 is an area for displaying various videos, images, icons, and the like. In this recording screen, a sound thumbnail image shown in the figure is displayed in the sub-screen area A2.

This sound thumbnail image plays a role of an icon indicating audio data obtained by a recording operation to be performed. As described later, recorded audio data and this sound thumbnail image are managed in association with each other. Consequently, the user can identify the audio data according to the sound thumbnail image.

The CPU 5 generates such a sound thumbnail image in advance at a stage before display of the recording screen. In this case, the operation for deciding the inputted text data is performed as indicated by <7> in FIG. 4, read-out data is generated, and, then, such a sound thumbnail image is generated. Here, since recording is performed for the first time, a sound thumbnail image indicating “take 1” is generated and displayed.

The text time code display area A3 is an area for displaying time information based on a text time code. The time limit display area A4 is an area for displaying inputted time limit information. The duration time display area A5 is an area for displaying information on a time length of an actually recorded sound after recording as a duration time.

In the editing apparatus 2, the recording screen is automatically displayed because the operation for deciding the inputted text data is performed to generate the read-out data and the sound thumbnail image.

In a state in which this recording screen is displayed on the display unit 15, recording of the narration sound is performed.

Specifically, in the state in which the recording screen is displayed, when a predetermined operation input for instructing start of recording is obtained as an operation input from the operation unit 9 shown in FIG. 2, the editing apparatus 2 starts a recording operation for an input sound from the audio input terminal TAin according to the operation input.

At the same time, as shown in FIG. 6, the editing apparatus 2 starts an operation for indicating, with an intend bar IB displayed to be superimposed on characters displayed in the text display area A1, a character position where characters should be read out at present.

Specifically, the editing apparatus 2 performs, on the basis of read-out timing of respective characters indicated by the text time code of the read-out data, an operation for gradually extending the intend bar IB in an arrow direction in the figure such that the respective characters displayed in the text display area A1 are sequentially intended.

According to such an operation, the intend bar IB gradually proceeds on the displayed character string as time elapses.

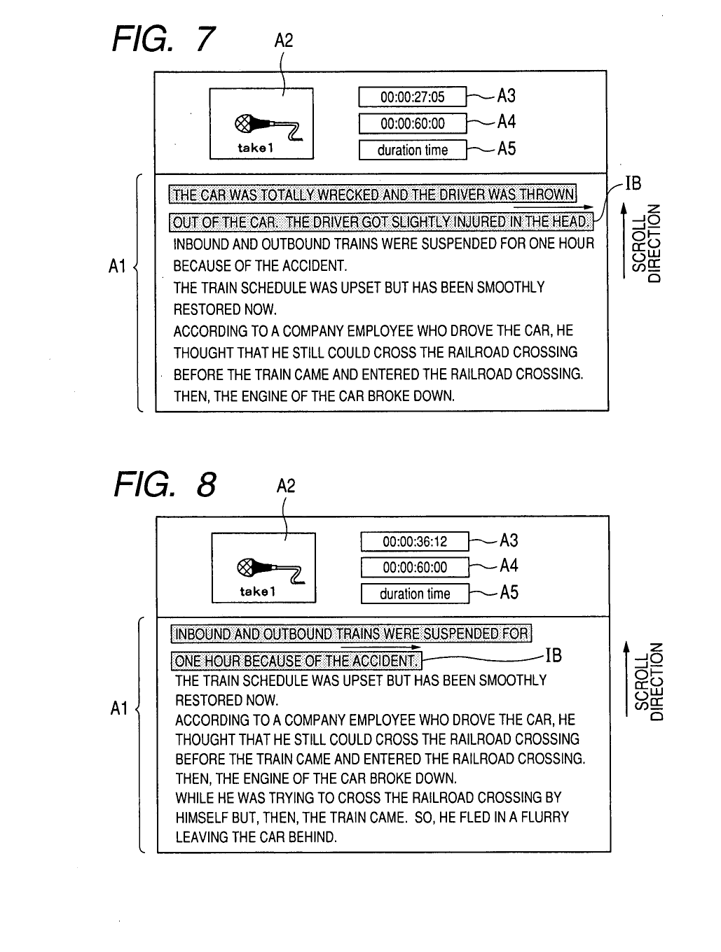

When all the characters of the inputted text data are not fully displayed in the text display area A1, first, characters that can be displayed are displayed as described above. As shown in FIGS. 7 and 8, the following character strings are sequentially displayed by scrolling all the character strings displayed in the text display area A1 in a scroll direction in the figures.

At this point, naturally, if characters that should be read out are not displayed in the text display area A1, it is difficult to properly support read-out of the script. Thus, the scroll needs to be performed in a state in which the characters that should be readout are typically displayed. In this case, since it is possible to grasp, according to the text time code of the read-out data, a character position of characters that should be read out at present, a scroll operation is also performed on the basis of information on this text time code. Specifically, execution timing of the scroll is controlled such that characters attached with text time codes indicating the present timing are displayed in the text display area. Consequently, it is possible to sequentially display the following character strings such that characters that should be read out are typically displayed.

As described above, during the recording of the narration sound, read-out positions at the time when the script is read at the predetermined read-out speed are sequentially indicated by the intend bar IB. Therefore, the user can easily read out the script at the predetermined read-out speed within a predetermined time limit by reading out the displayed character strings in accordance with the read-out positions.

As a result, in the editing system 1 according to this embodiment, even when a person assumed to be unaccustomed to script read-out such as a reporter or a cameraman records a narration sound, it is possible to support the person to allow to easily read out the script within a time limit.

When the user reads out all the displayed characters on the basis of such a recording support operation and stops the recording, the user can instruct stop of the recording by performing predetermined operation of a stop key or the like provided in the operation unit 9.

In the editing apparatus 2, first, the recording operation for the input sound is stopped on the basis of the instruction for stop of the recording. Then, an audio data file (simply referred to as an audio file) based on audio data recorded is generated. This audio file and the image data as the sound thumbnail image generated earlier are associated with each other.

Although not shown in the figure, according to the stop of the recording, information on a time length of the audio data actually recorded is displayed in the duration time display area A5 in the recording screen.

In this case, in the editing apparatus 2, a preview play operation is performed according to the end of the recording operation.

As this preview play, the audio file obtained by the recording operation is reproduced from the head thereof and the audio file is outputted from the speaker SP shown in FIG. 2. Moreover, in this case, in synchronization with the reproduction and the output of the recorded sound, text intend display same as the display during the recording is performed on the display unit 15. Screen transition on the display unit 15 during such preview play is the same as the screen transition shown in FIGS. 6 to 8. Thus, a repeated explanation of the screen transition is omitted.

When the preview play is finished, an operation for accepting correction of a sound is performed.

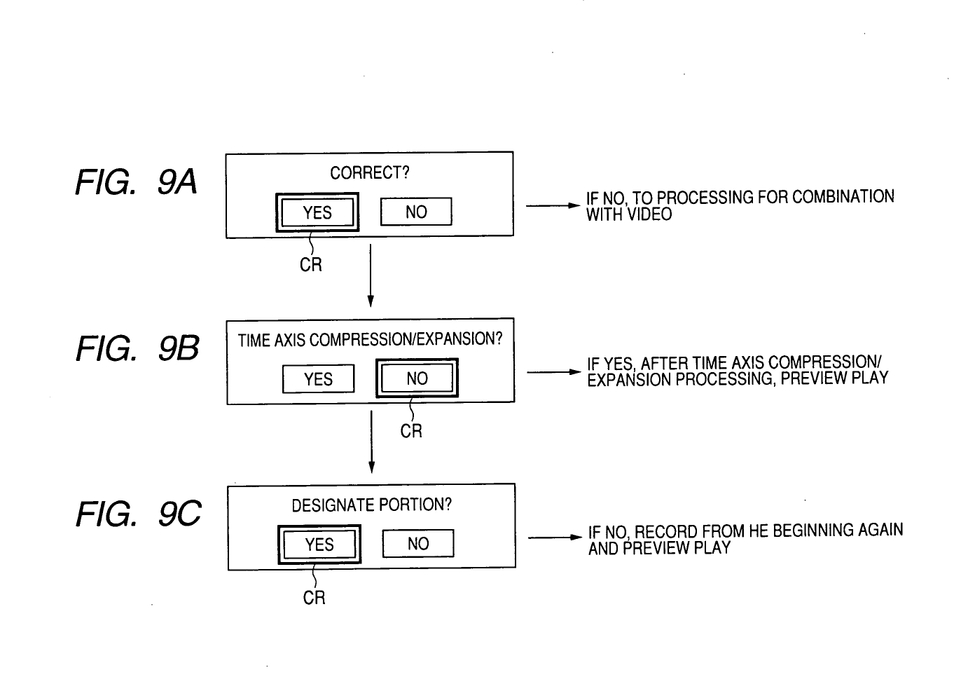

FIGS. 9A to 9C show an example of transition of a screen displayed on the display unit 15 in association with the time of the reception of correction.

When the preview play is finished, the editing apparatus 2 displays a correction acceptance screen shown in FIG. 9A on the display unit 15. As this correction acceptance screen, as shown in the figure, icons indicating items of Yes and No and a cursor CR for selecting the icons are displayed together with a question message such as “correct?”.

In this correction acceptance screen, the user can move the cursor CR by performing predetermined operation of a direction key or the like provided in the operation unit 9. Consequently, the user can select Yes and No. Further, the user can determine the item selected using the cursor CR according to operation of a predetermined key such as the determination key provided in the operation unit 9.

When, on the correction acceptance screen, the item of Yes is determined and it is decided that correction is performed, a time axis compression/expansion acceptance screen explained next is displayed.

When No is determined and it is decided that correction is not performed, the editing apparatus 2 shifts to processing for combination with a video described later.

FIG. 9B shows an example of the time axis compression/expansion acceptance screen.

As this time axis compression/expansion acceptance screen, the icons indication Yes and No and the cursor CR for selecting the icons are also displayed together with a question message such as “time axis compression/expansion?”. In this case, as in the above case, the user can move the cursor CR by performing the predetermined operation of the direction key or the like of the operation unit 9 and select the items of Yes and No. Further, the user can determine the item selected according to predetermined operation of the determination key or the like of the operation unit 9.

When, on the time axis compression/expansion acceptance screen, the item of Yes is determined and it is selected that the time axis compression/expansion processing is performed, after time axis compression/expansion processing for recorded audio data is performed, preview play based on the audio data after the processing is performed.

Specifically, although not explained with reference to the figures, when the item of Yes is selected on the time axis compression/expansion reception screen, an information input screen for a target time length is displayed on the display unit 15 and reception of input operation for a target time length of compression and expansion is performed. According to the operation for deciding (determining) inputted time information, time axis compression/expansion processing is performed by the signal processing unit 4 shown in FIG. 2 such that a time length of the recorded audio data becomes equal to the time length decided.

In this embodiment, an audio file generated anew by the time axis compression/expansion processing or re-recording described later is treated as an audio file separate from an audio file obtained during initial recording. In other words, the audio file obtained anew is not overwritten on the audio file obtained during the initial recording.

Therefore, after an sound thumbnail image separate from a sound thumbnail image generated during the initial recording is generated and, then, the audio file obtained anew is associated with the sound thumbnail image. Specifically, in this case, since the sound thumbnail image generated during the initial recording indicates contents of “take 1”, a sound thumbnail image indicating a take number corresponding to the number of times of generation of new audio files involved in correction is generated as the new sound thumbnail image.

When the new audio file is generated by the time axis compression/expansion processing in this way, audio data of the audio file is also preview-played.

The preview play in this case is also performed while the inputted text is intend-displayed in the same manner as that during the initial preview play. However, in this case, since the audio data is compressed or expanded in the time axis direction, it is likely that a gap occurs between intend timing of characters and timing of speech of the characters by reproduced sound unless the audio data is corrected.

Thus, prior to the preview play after the time axis compression/expansion processing, an operation for correcting the text time code in the read-out data is performed according to a ratio of an original target time length (a time limit length) inputted before the recording to a compression/expansion target time length inputted as a target time length of the compression/expansion processing. As the preview play in this case, the respective characters are intend-displayed at timing indicated by the text time code corrected in this way.

Consequently, it is possible to synchronize intend timing of the respective characters during the preview play according to the time axis compression/expansion of the audio data.

Just for confirmation, screen transition on the display unit 15 during the preview play in this case is the same as the screen transition shown in FIGS. 6 to 8. Thus, a repeated explanation of the screen transition is omitted.

According to such time axis compression/expansion processing, by setting the target time length, the user can create a narration sound within the time limit without reading out the script again. In other words, since the time axis compression/expansion processing is possible, it is possible to support the user to allow the user to more easily create the narration sound within the time limit.

When, on the time axis compression/expansion reception screen shown in FIG. 9B, the item of No is determined and it is selected that the time axis compression/expansion processing is not performed, a portion designation acceptance screen shown in FIG. 9C is displayed.

In FIG. 9C, on this portion designation acceptance screen, the icons indicating the items of Yes and No and the cursor CR for selecting the icons are displayed together with a question message such as “designate a portion?”. In this case, as in the above case, the user can move the cursor CR by performing the predetermined operation of the direction key or the like of the operation unit 9 and select the items of Yes and No. Further, the user can determine the item selected according to predetermined operation of the determination key or the like of the operation unit 9.

When the item of No is selected and determined on the portion designation acceptance screen, an operation for re-recording a narration sound from the beginning is performed and, then, preview play based on the re-recorded sound is performed.

In this case, as the re-recording operation, an operation same as that during the initial recording is performed. The recording screen shown in FIG. 5 is displayed on the display unit 15 again and the recording operation and a text intend display operation described as the screen transition in FIGS. 6 to 8 are started according to a recording start instruction. The recording operation is stopped according to a recording stop instruction and an audio file based on the recorded audio data is generated.

During the initial recording, since the image indicating “take 1” is generated as the sound thumbnail image, the image indicating “take 1” is also displayed as a sound thumbnail image on the sub-screen area A2. However, as described above, since a sound thumbnail image indicating a value of the next take is generated a new during re-recording, the sound thumbnail image indicating the value of the next take generated anew in this way is displayed in the sub-screen area A2 of the recording screen during this re-recording operation.

Then, preview play is performed for the audio file generated by the re-recording operation in this way. The preview play in this case is also performed while the inputted text is intend-displayed in the same manner as that during the initial preview play. Screen transition on the display unit 15 in that case is the same as the screen transition shown in FIGS. 6 to 8.

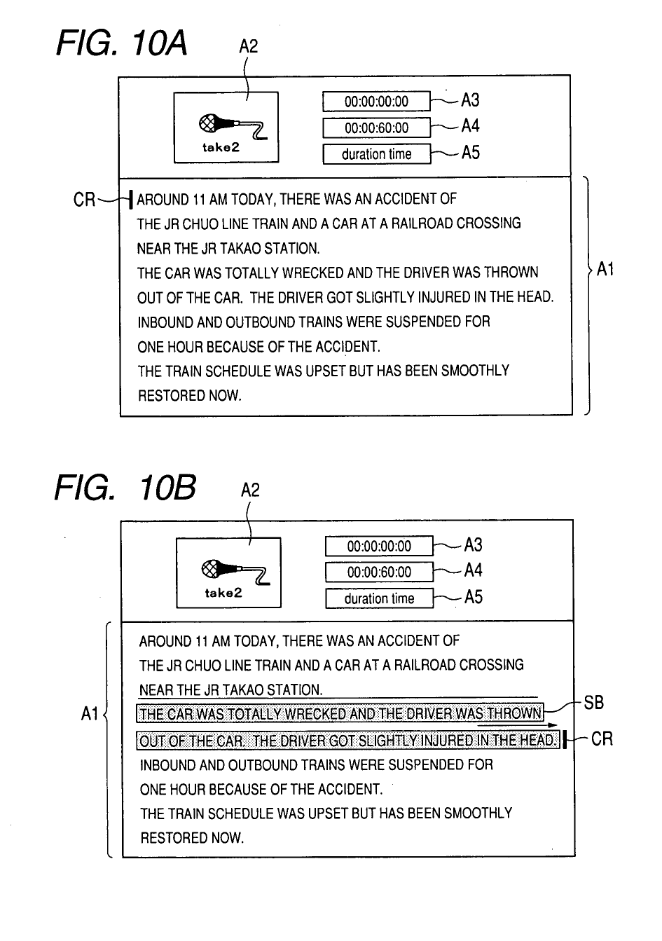

When, on the portion designation acceptance screen shown in FIG. 9C, the item of Yes is selected and determined and it is selected that portion designation is performed, a portion designating screen shown in FIGS. 10A and 10B is displayed on the display unit 15 and portion designating operation is accepted.

In FIGS. 10A and 10B, in this portion designating screen, the text display area A1, the sub-screen area A2, the text time code display area A3, the time limit display area A4, and the duration time display area A5 are provided as in the recording screen shown in FIG. 5. However, in the sub-screen area A2, a sound thumbnail image indicating a value of the next take is displayed because re-recording is performed. Here, as an example, display of a sound thumbnail image for “take 2” is displayed according to re-recording in the first time.

On this portion designating screen, the cursor CR for designating a range of a re-recording portion is displayed in the text display area A1.

The user can move a position of the cursor CR by a unit of one character of text data displayed in the text display area A1 by operating, for example, the direction key provided in the operation unit 9. The user can select a character string with a range designation bar SB as shown in FIG. 10B y performing operation for moving the cursor CR with the direction key while pressing, for example, another predetermined key in the operation unit 9. Moreover, the user can decide a range selected by the range designation bar SB by stopping the operation for pressing the predetermined key.

Since the designation of the range of the re-recording portion is performed in this way, in the editing apparatus 2, an operation for re-recording of the portion of the range designated is performed.

Although not explained with reference to the drawings, as the operation for re-recording in this case, for example, as in FIGS. 10A and 10B, a screen including the text display area A1, the sub-screen area A2, the text time code display area A3, the time limit display area A4, and the duration time display area A5 is displayed and at least character strings of a range designated is displayed.

In that state, according to a recording start instruction, a recording operation is started and intend display of characters is started from the head of the range-designated portion displayed in the text display area A1. In this case, the intend display is finished when the last character in the designated range is covered. The recording operation is stopped at the same timing.

In this way, a re-recorded sound for the designated portion is obtained. Since re-recorded audio data is obtained, first, the editing apparatus 2 performs preview play for the re-recorded portion. Reproduction and output for the re-recorded audio data is performed and screen display (intend display of the character strings of the range designated) same as that during the re-recording operation for the designated range is performed on the display unit 15.

In this case, as in the above case, after the preview play, the correction acceptance screen for accepting correction is displayed. Display contents of the correction acceptance screen are the same as those shown in FIG. 9A. When Yes is determined in the correction acceptance screen displayed, an operation same as the operation for re-recording the designated portion is performed to obtain a re-recorded sound for the designated portion again.

Thereafter, preview play for this re-recorded portion is performed. After the preview play, the correction acceptance screen for accepting correction for the re-recorded portion is displayed again. According to such operations, it is possible to re-record the designated portion until No is determined and audio data of the re-recorded portion is decided in the correction acceptance screen after the preview play.

On the other hand, after the preview play for the re-recorded portion, when No is determined in the correction acceptance screen for the re-recorded portion and the re-recorded audio data is decided, audio data of a portion corresponding to the designated portion in the original audio data is replaced with the audio data of the designated portion obtained by the re-recording to generate a new audio file.

According to the above explanation, in the range designation in this case, a range of text data is designated and a range of audio data is not directly designated.

However, as explained with reference to FIG. 2, in the editing apparatus 2, the CPU 5 attaches the audio time code to the recorded sound. Therefore, it is possible to specify, on the basis of the audio time code, a data portion corresponding thereto of the audio data from the text time codes of the portion of the range designated. Specifically, a range on a time axis is specified according to values of a text time code of a start character position in the portion of the range designated and a text time code of an end character position of the portion. In this way, it is possible to specify an audio data portion corresponding to the range designated in the text data.

After replacing the corresponding portion of the original audio data with the re-recorded audio data in this way to generate the new audio file, preview play is performed for entire audio data as this new audio file. In the preview play in this case, as in the above case, screen transition on the display unit 15 is the same as the screen transition shown in FIGS. 6 to 8.

Although not explained with reference to the drawings, the correction acceptance screen shown in FIG. 9A is displayed at timing after the preview play for the audio file generated by replacing the designated portion as well as timing after the preview play after the time axis compression/expansion processing is performed and after the preview play after the re-recording from the beginning to make it possible to accept correction again.

Consequently, it is possible to accept correction until No is determined in the correction acceptance screen and audio data after correction is decided.

Operations in combining separately photographed and edited videos with a sound obtained by the recording operation explained above to generate an AV file as news contents will be explained.

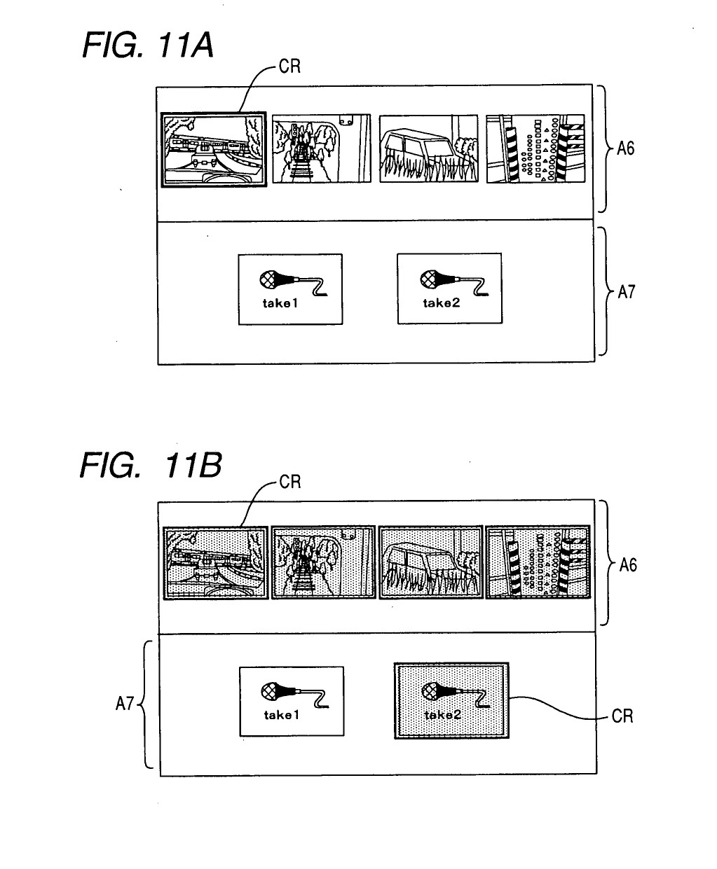

FIGS. 11A and 11B show examples of a sound/video combination screen that should be displayed on the display unit 15 in association with the time of combination of an audio video with the recorded sound.

First, when the user performs combination of a sound and a video, the user can cause the editing apparatus 2 to display the sound/video combining screen shown in FIG. 11A by operating a predetermined operation key of the operation unit 9.

In this sound/video combination screen, a video clip display area A6 and a sound thumbnail display area A7 are provided as shown in the figure.

In the video clip display area A6, thumbnail images (referred to as video thumbnail images to be distinguished from the sound thumbnail image) for video clips separately photographed and edited are displayed.

In this case, the video clips are obtained by cutting (editing) video data, which are material videos photographed by an external camera apparatus. Specifically, a series of news video is formed by joining a plurality of the video data.

As the video thumbnail images in the video clip display area A6, for example, video thumbnail images obtained by reducing frame image data located at the head on a time axis among frame image data forming respective video clips to a predetermined pixel size are displayed. In the example in FIGS. 11A and 11B, there are four object video clips and four video thumbnail images corresponding to the respective video clips are displayed.

In this case, it is assumed that the respective video clips are recorded in the optical disk D. In the editing apparatus 2, respective frame image data obtained by reproducing video data, which are the respective video clips recorded in the optical disk D in this way, are displayed as the video thumbnail images.

In the sound thumbnail display area A7, sound thumbnail images indicating audio files generated by the recording operation explained above are displayed. Here, there are two audio files obtained by the recording operation and two sound thumbnail images of “take 1” and “take 2” are displayed in the sound thumbnail display area A7.

On the sound/video combination screen, the cursor CR for selecting a video clip and an audio file to be set as combination objects is also displayed as shown in the figure.

In this case, as in the above case, the user can move the cursor CR by performing predetermined operation of the direction key or the like of the operation unit 9. Consequently, the user can select video thumbnail images (video clips) that should be set as combination objects. Further, the user can determine (decide) the selected video clips as the combination objects by performing predetermined operation of the determination key or the like of the operation unit 9.

At this point, the user can also determine an order of reproduction of video clips in an order of decision of the video clips. In this case, as shown in FIG. 11B, for example, the video clips (the video thumbnail images) decided are displayed with a color to clearly indicate that the video clips are decided.

When the video clips to be set as the combination objects and the order of reproduction of the video clips are decided in this way, the user can further move the cursor CR to the sound thumbnail display area A7 and select and decide a sound thumbnail image of an audio file to be set as a combination object. When the sound thumbnail image is selected and decided here, the video clips and the audio file that should be set as combination objects are finally decided. Consequently, the editing apparatus 2 performs combination processing for the video clips and the audio file decided.

Such combination processing for the video clips and the audio file is performed by the signal processing unit 4 shown in FIG. 2.

In this case, first, on the basis of control by the CPU 5, the video clips decided are read out in an order conforming to the order of decision described above out of video clips recorded in the optical disk D by the disk drive 17. The signal processing unit 4 synchronizes audio data based on the audio file decided with a series of video data obtained by reading out the video clips to generate an AV file obtained by combining the video data and the audio data.

When the AV file obtained by combining the sound and the video is generated, the editing apparatus 2 performs preview play of the AV file. As the preview play in this case, at least the sound and the video combined only has to be reproduced. However, in this example, the text intend display performed during the recording support of the sound is also performed.

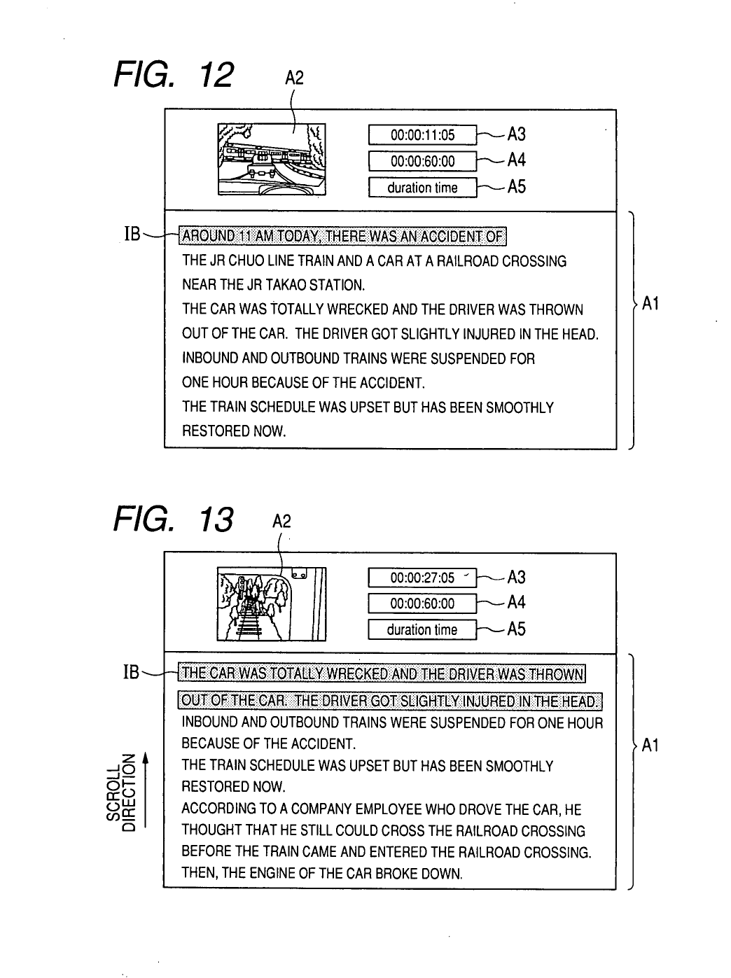

A state of the preview play is shown in FIGS. 12 to 14.

First, as shown in FIG. 12, as the preview play in this case, as in the preview play described above, the screen including the text display area A1, the sub-screen area A2, the text time code display area A3, the time limit display area A4, and the duration time display area A5, which is the same as the recording screen shown in FIG. 5, is displayed on the display unit 15.

However, since preview in this case is applied to the combined file of the sound and the video, a series of videos based on the video clips decided as the combination objects are displayed in the sub-screen area A2.

According to the start of the preview play, reproduction of the AV file generated is started, the video data is displayed in the sub-screen area A2, and the audio data is outputted from the speaker SP.

In the text display area A1, in this case, as in the above case, intend display of displayed characters by the intend bar IB shown in the figure is started.

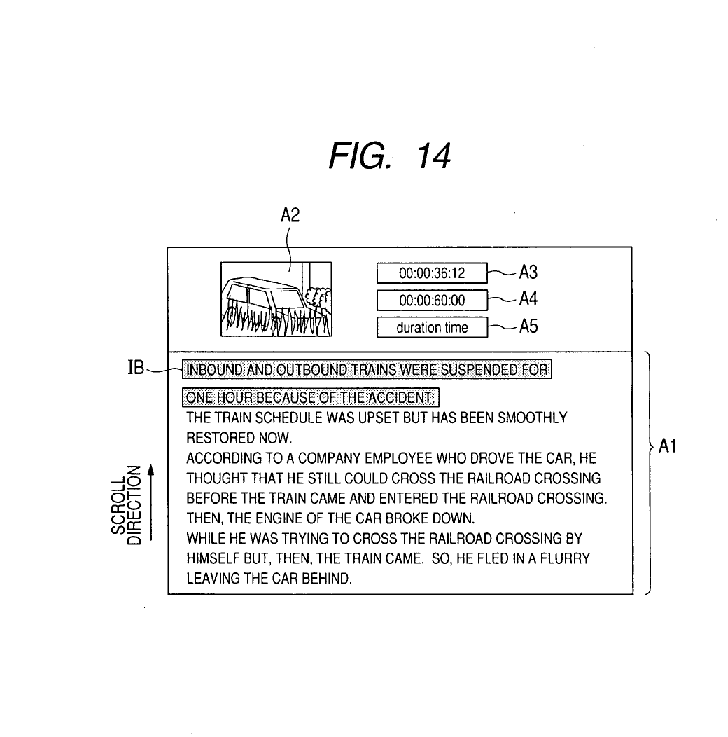

When all the characters of the inputted text data are not fully displayed in the text display area A1, as time elapses, as shown in FIGS. 13 and 14, the remaining characters are sequentially displayed by sequentially scrolling all the character strings displayed in the text display area A1.

Subsequently, after the preview play for the AV file shown in FIGS. 12 to 14, screen display for inquiring the user whether the AV file combined should be decided is performed. As this screen display, for example, according to a display form such as the correction acceptance screen shown in FIG. 9A, the icons of Yes and No are displayed together with a question message such as “preview is OK?”.

When No is selected and determined and the user judges that the AV file is not decided, the sound/video combination screen shown in FIG. 11A is displayed again to cause the user to reselect a video and a sound that should be set as combination objects.

On the other hand, when Yes is selected and determined and the user judges that the AV file is decided, the AV file generated is written in the optical disk D. In the case of this embodiment, the read-out data used during the recording is further written in association with the AV file that should be written in the optical disk D in this way.

As the read-out data, the text time code indicating read-out timing for each of the characters of the inputted text data is attached to the character as explained above. Therefore, by recording the read-out data in association with the AV file as described above, it is possible to record the inputted text data in synchronization with the video and the sound (in particular, the sound) of the AV file generated. In other words, concerning the AV file associated with the read-out data, by performing a reproduction operation conforming to the time codes of the sound and the video and the text time code, it is possible to reproduce the AV file to synchronize displayed characters and timing for speech by a reproduced sound.

If it is possible to synchronize the reproduced sound (and the reproduced video) and the display timing of the text data, it is possible to realize, for example, the closed-caption broadcast performed in television broadcasts under the present situation.

As a display form of characters in that case, it is possible to perform the intend display for each of displayed characters to be timed to coincide with speech timing of sounds as explained the embodiment. Alternatively, it is also possible to sequentially switch to display predetermined plural characters at timing synchronizing with the sounds.

Under the present situation, as the text data for the closed-caption broadcast, after producing broadcast contents, a text is inputted and inserted again as a so-called closed caption. In other words, under the present situation, when news contents are produced as in this example, despite the fact that the text data is inputted for creation of a news script before recording of the narration sound, a text data for the closed-caption broadcast is inputted after the input of the text data anew.

On the other hand, in the case of this example explained above, it is possible to directly use the text data, which is inputted as the news script (the narration script) during the recording, as text data for the closed-caption broadcast. In other words, it is possible to omit new input of the text data for the closed-caption broadcast after the content production under the present situation.

In the following explanation, the AV file in which the text data is synchronized with the video and the sound while being associated with the read-out data is also referred to as an AV/text file.

[Processing Operations]

Processing operations that should be performed in order to realize the operations by the editing system 1 according to the first embodiment explained above are explained with reference to flowcharts in FIGS. 15 to 18.

In FIGS. 15 to 18, the CPU 21 shown in FIG. 3 executes, on the basis of a PC side program 30a stored in the HDD 30, processing operations indicated as being performed by the personal computer. The CPU 5 shown in FIG. 2 executes, on the basis of the editing apparatus side program 6a stored in the ROM 6, processing operations indicated as being performed by the editing apparatus.

In FIG. 15, it is assumed that the editing apparatus 2 and the personal computer 3 are already connected to be capable of performing data communication.

FIG. 15 shows processing operations that should be performed in association with the time of operations from input of a time limit and text data to generation of read-out data (see FIG. 4).

In FIG. 15, first, on the personal computer 3 side, the CPU 21 executes processing for inputting a time limit length in step S101.

Specifically, in this case, the CPU 21 performs screen display for inputting text data and a time limit on the display 27 as described above and accepts input of a time limit length and input of text data by the mouse and the keyboard provided as the input unit 25 on the screen.

In step S101, in this way, the CPU 21 executes processing for accepting the input of the time limit first on the screen displayed on the display 27 and, then, displaying information on an inputted time length in a predetermined area on the screen.

In the following step S102, the CPU 21 performs processing for judging whether determination operation should be performed. In this case, the determination operation is performed using a determination button (icon) displayed on the screen. Specifically, in step S102, the CPU 21 judges whether predetermined operation such as left click operation of the mouse has been performed in a state in which this determination button on the screen is selected using a cursor also displayed on the screen.

When such determination operation has not been performed and a negative result is obtained, as shown in the figure, the CPU 21 returns to step S101 and continues to perform the processing for inputting a time limit length.

When it is judged that the determination operation has been performed and an affirmative result is obtained, the CPU 21 proceeds to step S103.

In step S103, the CPU 21 executes text input processing. Specifically, the CPU 21 performs processing for displaying text data corresponding to operation of the mouse and the keyboard of the input unit 25 on the input screen described above.

In the following step S104, the CPU 21 performs processing for judging whether determination processing should be performed. In this case, the determination operation is also performed using the determination button displayed on the input screen. Therefore, in step S104, as in step S102, the CPU 21 judges whether the predetermined operation in a state in which the determination button is selected using the cursor has been performed.

When the determination operation has not been performed, as shown in the figure, in step S103, the CPU 21 performs the processing for inputting text data.

On the other hand, when the determination operation has been performed and an affirmative result is obtained, the CPU 21 proceeds to step S105.

In step S105, the CPU 21 executes processing for transmitting the time limit length and the text data to the editing apparatus 2 side. Specifically, the CPU 21 controls the USB interface 23 to transmit information on the time limit length and the text data inputted and determined as described above to the editing apparatus 2 connected to the personal computer 3 via the USB terminal Tusb.

On the editing apparatus 2 side, the CPU 5 stands by for reception of the information on the time limit length and the text data in step S201. When the information and the text data are received, in step S202, the CPU 5 executes processing for calculating a read-out time for a text. Specifically, the CPU 5 supplies the text data received to the read-out time calculating/read-out data generating unit 16 shown in FIG. 2 and instructs the read-out time calculating/read-out data generating unit 16 to calculate a read-out time length of the text data. According to the instruction, the read-out time calculating/read-out data generating unit 16 calculates a read-out time length for the inputted text data and supplies a result of the calculation to the CPU 5.

In the following step S203, the CPU 5 performs processing for judging whether the read-out time length is within a time limit. Specifically, the CPU 5 performs processing for judging whether a value of the read-out time length calculated by the read-out time calculating/read-out data generating unit 16 as described above is equal to or smaller than a value of the time limit length received.

When, in step S203, the value of the read-out time length calculated is not equal to or smaller than the value of the time limit length received, it is judged that the read-out lime length is not within the time limit, and a negative result is obtained, the CPU 5 proceeds to step S204 and sends an error notification to the personal computer 3 side. Then, the CPU 5 proceeds to “RETURN” as shown in the figure.

When, in step S204, the value of the read-out time length calculated is equal to or smaller than the value of the time limit length received, it is judged that the read-out time length is within the time limit, and an affirmative result is obtained, the CPU 5 proceeds to step S205.

In step S205, the CPU 5 performs processing for judging whether the inputted text data should be decided.

The CPU 5 performs the judgment processing in step S205 by displaying a screen including at least a message for inquiring the user whether the text data should be decided, the icons of Yes and No, and the cursor CR for selecting the icons on the display unit 15. When the icon of No is selected and determined using the cursor CR on this display screen and a negative result indicating that the inputted text data is not decided is obtained, the CPU 5 proceeds to step S206 and sends a re-input notification to the personal computer 3 side. Thereafter, the CPU 5 proceeds to “RETURN” as shown in the figure.

When the icon of Yes is selected and determined using the cursor CR on the display screen and the inputted text data is decided in step S205, the CPU 5 proceeds to step S207 and sends a decision notification to the personal computer 3 side.

On the personal computer 3 side, after executing the processing for transmitting the time limit length and the text data described above (S105), in step S106, the CPU 21 stands by for any one of the error notification, the re-input notification, and the decision notification from the editing apparatus 2 side.

When any one of the notifications is received in step S106, in step S107, first, the CPU 21 performs processing for judging whether the notification is the error notification. When it is judged that the notification is the error notification and an affirmative result is obtained, the CPU 21 proceeds to step S109 and performs error display processing. Specifically, as explained with reference to FIG. 4, the CPU 21 executes processing for displaying an error message such as “the time limit is over” on the display 27. Thereafter, the CPU 21 returns to step S103 as shown in the figure to accept re-input (correction) of the text data.

The text data after the correction is transmitted to the editing apparatus 2 side according to the processing in step S105. On the editing apparatus 2 side, in step S203, the CPU 5 again performs the processing for judging whether a read-out time length of the text after the correction is within the time limit. According to such a flow, it is possible to correct the text data until the read-out time fits in the time limit.

When, in step S107, it is judged that the notification from the editing apparatus 2 side is not the error notification and a negative result is obtained, in step S108, the CPU 21 performs processing for judging whether the notification is the re-input notification. When it is judged that the notification is the re-input notification and an affirmative result is obtained, the CPU 21 returns to step S103. Consequently, it is possible to perform correction of the text data. Since it is possible to correct the text even if the read-out time is within the time limit in this way, for example, when a read-out time length of an inputted text is extremely short compared with the time limit, it is possible to perform correction of the text to cope with such a case.

When, in step S108, it is judged that the notification is not the re-input result and a negative result is obtained, the notification from the editing apparatus 2 is the decision notification. Therefore, since the re-input processing in the personal computer 3 is unnecessary, the CPU 21 finishes the processing operation as shown in the figure.

The processing on the editing apparatus 2 side will be explained again.

After sending the decision notification in step S207, as shown in the figure, the CPU 5 advances the processing to step S208 as shown in the figure.

In step S208, the CPU 5 executes processing for saving the text data. In this case, the CPU 5 records the text data received in the nonvolatile memory 8 shown in FIG. 2.

In the following step S209, the CPU 5 executes processing for generating read-out data with text time codes attached to respective characters. Specifically, the CPU 5 supplies the text data saved as described above to the read-out time calculating/read-out data generating unit 16 and instructs the read-out time calculating/read-out data generating unit 16 to generate read-out data with text time codes attached to respective characters of the text data.

The read-out data generated by the read-out time calculating/read-out data generating unit 16 is supplied to the CPU 5. The CPU 5 records the read-out data in, for example, the nonvolatile memory 8.

In step S210, the CPU 5 performs processing for generating a sound thumbnail image. As described above, in this example, different thumbnail images are associated with respective recorded sounds and the thumbnail images are managed separately. Specifically, the CPU 5 generates a sound thumbnail image indicating a take number conforming to the number of times of recording. Since a sound thumbnail image corresponding to an initial recording time is generated in step S210, specifically, the CPU 5 performs processing for generating image data as the sound thumbnail image indicating “take 1”.

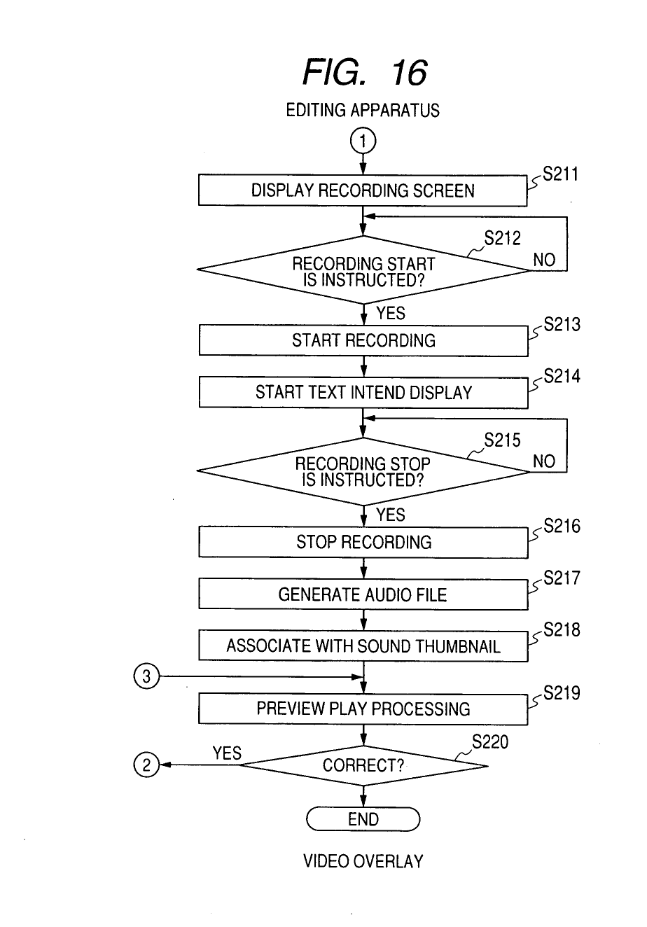

After executing the processing in step S210, the CPU 5 proceeds to step S211 shown in FIG. 16.

FIG. 16 mainly shows a processing operation that should be performed in the editing apparatus 2 side in association with the time of the recording support operation explained above (see FIGS. 6 to 8) in association with the recording support operation.

First, in step S211, the CPU 5 performs processing for displaying a recording screen. The CPU 5 executes processing for displaying the recording screen before recording (the initial state) shown in FIG. 5 on the display unit 15. Specifically, the CPU 5 supplies the text data, the sound thumbnail image, and the information on the time limit length recorded in the nonvolatile memory 8 to the character generator 13 and instructs the character generator 13 to display the text data, the sound thumbnail image, and the information on the time limit length in the predetermined positions (the text display area A1, the sub-screen display area A2, and the time limit display area A3), respectively.

In the following step S212, the CPU 5 stands by for an instruction for start of recording.

When, in step S212, a predetermined operation input for instructing start of recording is obtained as an operation input from the operation unit 9 and it is judged that the instruction for start of recording is received, the CPU 5 proceeds to step S213 and performs processing for starting recording. Specifically, the CPU 5 causes the signal processing unit 4 to start amplification processing and A/D conversion for an input sound from the audio input terminal TAin and starts an operation for recording audio data obtained by the amplification processing and the A/D conversion in the nonvolatile memory 8.

In the following step S214, the CPU 5 executes processing for starting text intend display.

Specifically, the CPU 5 starts an operation for instructing the character generator 13 to perform display of the intend bar IB such that respective characters displayed in the text display area A1 are sequentially intended at timing indicated by text time codes of the read-out data. When all the character strings are not fully displayed in the text display area A1, to cope with such a case, as in the above case, the CPU 5 starts an operation for giving an instruction about scroll timing based on the text time code to the character generator 13 to perform scroll display of all the character strings such that characters that should be readout are typically displayed.

In step S215, the CPU 5 stands by for an instruction for stop of recording.

When a predetermined operation input for instructing stop of recording is obtained as an operation input from the operation unit 9 and the instruction for stop of recording is received, the CPU 5 proceeds to step S216 and performs recording stop processing. In other words, the CPU 5 stops the operation for recording the inputted audio data in the nonvolatile memory 8 started in step S213.

Although an explanation referring to the drawings is omitted, when the recording of the audio data is finished in this way, the CPU 5 also performs processing for displaying, in the duration time display area A5 in the recording screen, information on a recording time length of audio data actually recorded.

In the subsequent step S217, the CPU 5 executes processing for generating an audio file. Specifically, the CPU 5 executes processing for generating an audio data file based on recorded audio data.

Then, in step S218, the CPU 5 performs processing for associating the audio file generated in this way and a sound thumbnail image.

In step S219, the CPU 5 executes preview play processing. According to the above explanation, as such preview play after recording, the CPU 5 outputs a recorded sound from the speaker SP and, at the same time, performs, on the display unit 15, intend display same as that on the recording screen displayed during the recording.

As the processing in step S219, the CPU 5 reproduces the audio file recorded in the nonvolatile memory 8 and supplies the audio file to the signal processing unit 4 to output the recorded sound from the speaker SP via the D/A converter 10 and the amplifier 11. At the same time, the CPU 5 gives an instruction same as that in step S214 to the character generator 13 to cause the character generator 13 to perform the text indent display (and the scroll display if necessary).

In the following step S220, the CPU 5 performs processing for judging whether the recorded sound should be corrected.

In step S220, first, the CPU 5 instructs the character generator 13 to display the correction acceptance screen shown in FIG. 9A on the display unit 15. Then, the CPU 5 judges whether any one of the icons of Yes and No displayed on the correction acceptance screen is selected and determined using the cursor CR.

When, in step S220, in a state in which the icon of No is selected, predetermined operation for determining a selected item such as the determination key in the operation unit 9 has been performed and a negative result indicating that the correction is not performed is obtained, the CPU 5 finishes the processing operation as shown in the figure.

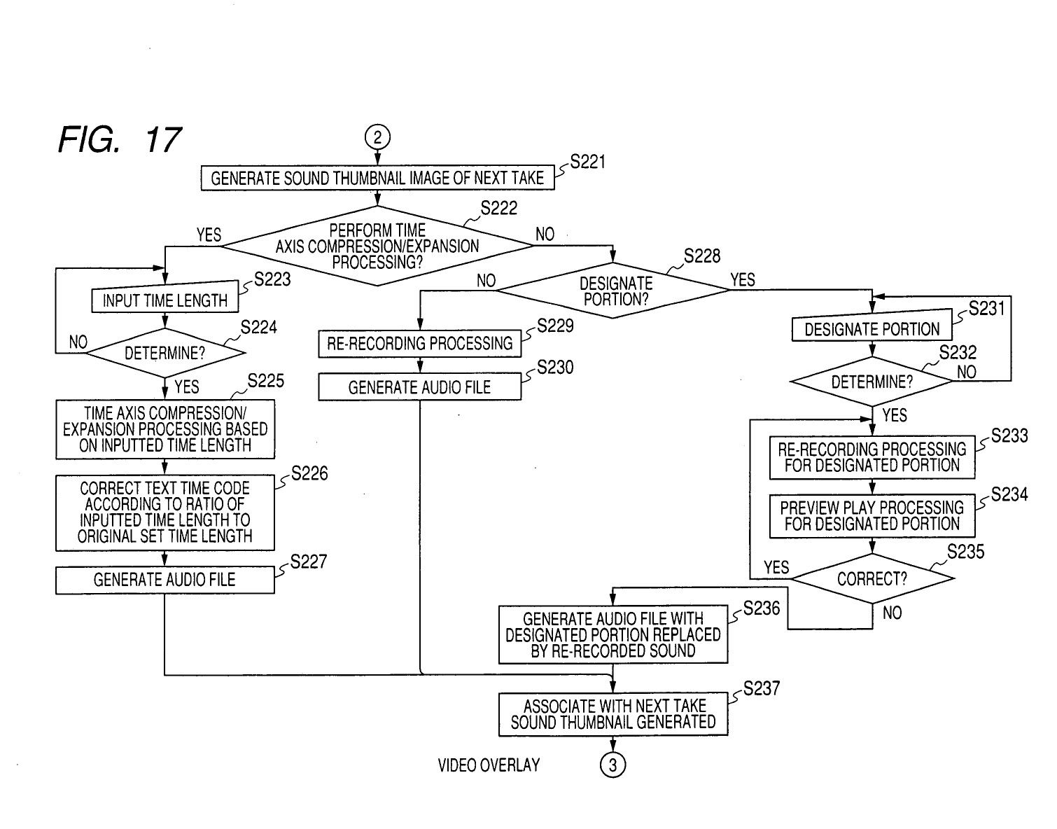

On the other hand, when, in step S220, in a state in which the icon of Yes is selected, predetermined operation for determining a selected item such as the determination key in the operation unit 9 has been performed, it is judged the correction is performed, and an affirmative result is obtained, the CPU 5 proceeds to step S221 shown in FIG. 17.

FIG. 17 mainly shows a processing operation that should be performed in the editing apparatus 2 in association with the time of the operation for correcting a recorded sound (see FIGS. 9 and 10).

In FIG. 17, in step S221, the CPU 5 generates a sound thumbnail image of the next take. Specifically, the CPU 5 generates sound thumbnail image data indicating a take number corresponding to the number of times of correction such as take 2 corresponding to correction for a first time and take 3 corresponding to correction for a third time.

In the subsequent step S222, the CPU 5 executes processing for judging whether time axis compression/expansion should be performed.

In step S222, first, the CPU 5 gives an instruction to the character generator 13 and controls the character generator 13 to display the time axis compression/expansion acceptance screen shown in FIG. 9B on the display unit 15. Then, as in the case of the correction acceptance screen, the CPU 5 judges whether one of the icons of Yes and No is selected and determined using the cursor CR.

When, in step S222, predetermined operation for determining a selected item such as the determination key in the operation unit 9 has been performed in a state in which the icon of Yes is selected and an affirmative result indicating that the time axis compression/expansion is performed is obtained, the CPU 5 proceeds to step S223.

On the other hand, when the predetermined operation for determining a selected item such as the determination key in the operation unit 9 is performed in a state in which the icon of No is selected and a negative result indicating that the time axis compression/expansion is not performed is obtained, the CPU 5 proceeds to step S228.

First, in step S223 corresponding to the case in which the time axis compression/expansion is performed, the CPU 5 performs processing for inputting a time length. Specifically, the CPU 5 instructs the character generator 13 to display a screen for inputting information on a target time length on the display unit 15 and display, according to operation for inputting a time length, a numerical value of the time length.

In the subsequent step S224, the CPU 5 performs processing for judging whether operation for determining the information on the time length inputted should be performed. In this case, for example, when predetermined determination operation of the determination key or the like in the operation unit 9 is not performed and a negative result is obtained, the CPU 5 continues to perform the processing for inputting a time length in step S223.

On the other hand, for example, when the predetermined determination operation of the determination key or the like in the operation unit 9 is performed and an affirmative result is obtained, in step S225, the CPU 5 performs time axis compression/expansion processing based on the inputted time length. Specifically, the CPU 5 supplies information on the inputted time length determined and the audio data recorded to the signal processing unit 4 and instructs the signal processing unit 4 to perform the time axis compression/expansion processing such that a time length of the audio data becomes equal to the inputted time length.

The signal processing unit 4 supplies audio data generated by this time axis compression/expansion processing to the CPU 5.

In step S266, the CPU 5 executes processing for correcting the text time code according to a ratio of an original input time length to the target time length.

Specifically, the CPU 5 executes processing for correcting the text time code in read-out data according to a ratio of an original target time length inputted during generation of the audio file set as the time axis compression/expansion processing of this time to the target time length of the compression/expansion processing inputted in step S223.

The original inputted time length is the information on the time limit length received in step S201 in FIG. 15 when the time axis compression/expansion processing of this time is time axis compression/expansion processing for the first time. However, it is possible to perform the time axis compression/expansion processing for plural times. An original input time length in that case is information on a target time length inputted in association with the time of the time axis compression/expansion processing performed immediately before the time axis compression/expansion processing of this time.

In the subsequent step S227, the CPU 5 generates an audio file. Specifically, the CPU 5 generates an audio file based on the audio data generated and subjected to the time axis compression/expansion processing by the signal processing unit 4.

When the audio file is generated in this way, the CPU 5 proceeds to step S237 and performs processing for associating the audio file with the sound thumbnail of the next take generated. In other words, the audio file generated is associated with the sound thumbnail image generated in step S221.

After executing the processing in step S237, the CPU 5 returns to step S219 in FIG. 16 as shown in the figure and executes the preview play processing again. Consequently, preview play based on the audio file after the correction is performed.

After this preview play, the CPU 5 performs the processing for judging whether the recorded sound should be corrected in step S220. Consequently, as described above, the CPU 5 accepts correction of the recorded sound until the correction is decided.

Subsequently, in FIG. 17, in step S228 corresponding to the case in which the time axis compression/expansion is not performed, the CPU 5 performs processing for judging whether portion designation should be performed.

In step S228, first, the CPU 5 instructs the character generator 13 to display the portion designation acceptance screen shown in FIG. 9C on the display unit 15. Then, in this case, as in the above case, the CPU 5 judges whether one of the icons of Yes and No is selected and determined using the cursor CR.

When, in step S228, predetermined determination operation of the determination key or the like in the operation unit 9 has been performed in a state in which the icon of No is selected and a negative result indicating that the portion designation is not performed is obtained, the CPU 5 proceeds to step S229 and executes re-recording processing.

Specifically, in order to re-record a narration sound from the beginning, first, the CPU 5 instructs the character generator 13 to display the recording screen of the initial state shown in FIG. 5 again. Then, the CPU 5 stands by for an instruction for start of recording and, when the instruction for start of recording is received, executes processing same as that in steps S214 to S216 in FIG. 16 and performs recording of sounds and text intend display.

In step S230, the CPU 5 generates an audio file based on audio data recorded by such re-recording processing.

After generating the audio file in this way, in this case, the CPU 5 also proceeds to step S237 explained above and, after performing processing for associating the audio file with the sound thumbnail of the next take generated, returns to step S219 in FIG. 16.

On the other hand, when, in step S228, the predetermined determination operation of the determination key or the like in the operation unit 9 is performed in a state in which the icon of Yes is selected and an affirmative result indicating that the portion designation is performed is obtained, the CPU 5 proceeds to step S231 and executes the portion designation processing.

In step S231, first, the CPU 5 instructs the character generator 13 to display the portion designating screen shown in FIGS. 10A and 10B on the display unit 15. Then, according to operation of, for example, the direction key of the operation unit 9, the CPU 5 performs processing for moving the cursor CR for designating a range of a re-recorded portion displayed on this portion designating screen. According to cursor moving operation by the direction key in a state in which another predetermined key different from the direction key is operated, the CPU 5 performs processing for extending display of the range designation bar SB and indicating a selection range of character strings.

In the subsequent step S232, the CPU 5 performs processing for judging whether a selection range has been determined. In this case, according to the above explanation, a range selected using the range designation bar SB is decided by releasing the predetermined key pressed together with the direction key. Thus, in step S232, the CPU 5 performs processing for judging whether an operation input by the predetermined key has been finished.

When it is judged that the operation input by the predetermined key has not been finished and the selection range has not been determined (decided) yet and a negative result is obtained, the CPU 5 continues to perform the portion designation processing in step S231.

On the other hand, when it is judged that the operation input by the predetermined key has been finished and the selection range has been determined (decided) and an affirmative result is obtained, the CPU 5 proceeds to step S233 and executes processing for re-recording the designated portion.

As explained above, as such processing for re-recording the designated portion, for example, as in FIG. 10, the screen including the text display area A1, the sub-screen area A2, the text time code display area A3, the time limit display area A4, and the duration time display area A5 is displayed on the display unit 15 to display a character string of the designated portion in the text display area A1.

In that state, according to an instruction for start of recording, the CPU 5 starts an operation for recording audio data inputted via the audio input terminal TAin and the signal processing unit 4. At the same time, the CPU 5 instructs the character generator 13 to start intend display of characters from the head of the designated portion displayed in the text display area A1. In this case, the intend display is finished when the intend display covers the last character in the designated area. The recording operation is stopped at the same timing.

When the processing for re-recording the designated portion is finished, in the next step S234, the CPU 5 performs processing for preview play of the re-recorded portion. Specifically, the CPU 5 generates re-recorded audio data, supplies the re-recorded audio data to the signal processing unit 4, and causes the signal processing unit 4 to start a sound output from the speaker SP. At the same time, the CPU 5 instructs the character generator 13 to perform screen display same as that during the processing for re-recording the designated portion on the display unit 15.

In the subsequent step S235, the CPU 5 performs processing for judging whether the designated portion should be corrected. As the judgment processing in step S235, the CPU 5 instructs the character generator 13 to display a correction acceptance screen same as that shown in FIG. 9A and, then, judges whether one of the icons of Yes and No on the screen is selected and determined using the cursor CR.

When, in step S235, the icon of Yes has been determined and an affirmative result indicating that the correction is performed is obtained, the CPU 5 returns to step S233 and performs the re-recording processing for the designated portion again. In other words, in the operation for re-recording the designated portion, the CPU 5 accepts correction until the correction is decided.

On the other hand, when, in step S235, the icon of No has been determined and a negative result indicating that the correction is not performed is obtained, in step S236, the CPU 5 generates an audio file with the designated portion replaced with the re-recorded portion.

As described above, the range designation in this case is performed by designating a range in text data. Thus, it is necessary to perform processing for applying the designated range to audio data. In this case, since the CPU 5 attaches a audio time code to recorded audio data, the CPU 5 specifies a data portion in the audio data corresponding to the designated range on the basis of this audio time code and the text time code of the text portion designated as described above.

Then, the CPU 5 replaces the audio data portion specified in this way with the audio data obtained by the re-recording processing in step S233 to generate an audio file.

After generating the audio file with the designated portion replaced with the re-recorded sound, the CPU 5 proceeds to step S237 and, after performing processing for associating the audio file with the sound thumbnail image generated, proceeds to step S219 in FIG. 16.

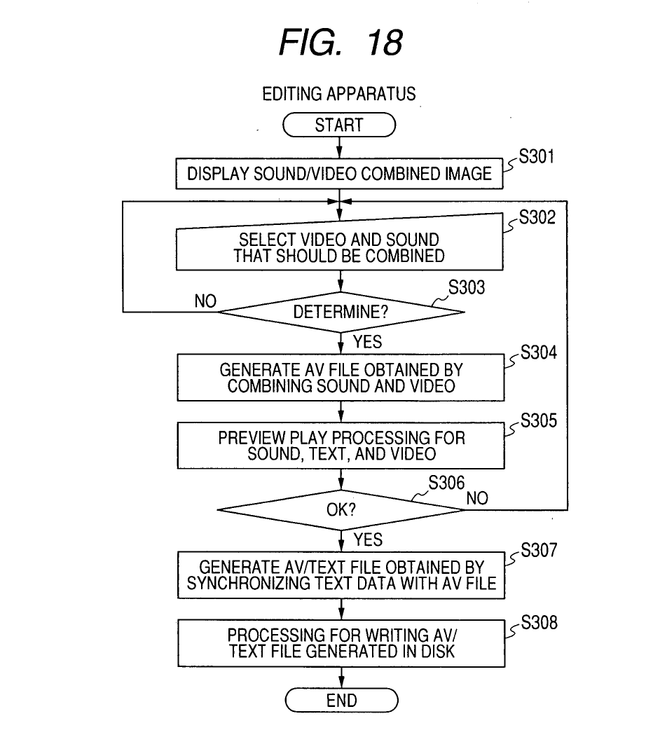

FIG. 18 mainly shows a processing operation that should be performed in the editing apparatus 2 in association with the time of the processing for combining a sound and a video (see FIGS. 11 to 14).

In FIG. 18, first, in step S301, the CPU 5 performs processing for displaying a sound/video combination screen. Specifically, the CPU 5 instructs the character generator 13 to display the sound/video combination screen shown in FIG. 11A on the display unit 15.

In this case, as the sound/video combination screen, video thumbnail images of video clips separately photographed and edited are displayed in the video clip display area A6. Therefore, first, the CPU 5 controls the disk drive 17 to reproduce video data, which are the respective video clips recorded in the optical disk D, and supplies predetermined frame image data (in this case, frame image data at the head) of respective video data, which are obtained by the reproduction, to the character generator 13 as the video thumbnail images. As the sound thumbnail images that should be displayed in the sound thumbnail display area 7A, the CPU 5 supplies the sound thumbnail image data generated in the recording processing (FIGS. 15 to 17) to the character generator 13.

Such processing for displaying the sound/video combination screen only has to be executed according to predetermined operation via the operation unit 9.

In step S302, the CPU 5 performs processing for selecting a video and a sound that should be combined.

Specifically, the CPU 5 instructs the character generator 13 to move the cursor CR, which is displayed on the sound/video combination screen, according to predetermined operation of the direction key or the like of the operation unit 9. At the same time, the CPU 5 instructs the character generator 13 to perform display (in this case, display with a color) for clearly indicating that video thumbnail images and sound thumbnail images selected using the cursor CR have been determined according to the predetermined determination operation of the determination key or the like of the operation unit 9.

In this case, as described above, an order of determination (an order of decision) of the video thumbnail images in the sound/video combination screen determines an order of reproduction of video clips after combination. Thus, in step S302, the editing apparatus also performs processing for storing such an order of decision of the video thumbnail images.

In the subsequent step S303, the CPU 5 performs processing for judging whether a video and a sound that should be combined have been determined. In this case, the determination of a video and a sound that should be combined is performed, after video thumbnail images that should be combined are determined, according to the determination of sound thumbnail images that should be combined. Thus, the CPU 5 performs the judgment processing in step S303 by judging whether operation for determining any one of the sound thumbnail images has been performed.

When, in step S303, it is judged that the operation for determining a sound thumbnail image has not been performed and a sound and a video that should be combined have not been determined and a negative result is obtained, the CPU 5 continues to perform the selection processing in step S302.

On the other hand, when, in step S303, it is judged that the operation for determining a sound thumbnail image has been performed and a sound and a video that should be combined have been decided and an affirmative result is obtained, the CPU 5 proceeds to step S304 and generates an AV file obtained by combining the sound and the video.

As the processing in step S304, first, the CPU 5 controls the disk drive 17 to read out determined (decided) video clips out of the video clips recorded in the optical disk D in an order conforming to the determination order described above. The CPU 5 supplies a series of video data, which are obtained by reading out the video clips, and a determined audio file to the signal processing unit 4 and instructs the signal processing unit to combine the video data and the audio file.

The signal processing unit 4 synchronizes the series of video data supplied and audio data based on the audio file to generate an AV file obtained by combining the video data and the audio data.

In the subsequent step S305, the CPU 5 performs processing for preview play of sounds, texts, and videos.

As the preview play processing in this case, as in the preview play processing described above, the CPU 5 displays the screen including the text display area A1, the sub-screen area A2, the text time code display area A3, the time limit display area A4, and the duration time display area A5, which is the same as the recording screen shown in FIG. 5, on the display unit 15. Then, in this case, the CPU 5 supplies video data obtained by reproducing the AV file to the character generator 13 to instruct the character generator 13 to perform video display in the sub-screen area A2. At the same time, in this case, as in the above case, the CPU 5 sequentially informs the character generator 13 of intend timing of display characters by the intend bar IB on the basis of text time codes such that the text intend display is performed in the text display area A1. Moreover, when necessary, the CPU 5 also performs processing for informing scroll timing of displayed character strings on the basis of text time codes.

In step S306, the CPU 5 performs processing for judging whether the AV file generated is acceptable.

In step S306, first, the CPU 5 performs, on the display unit 15, screen display for inquiring the user whether the AV file generated should be decided. As this screen display, for example, according to a display form such as the correction acceptance screen shown in FIG. 9A, the CPU 5 displays the icons of Yes and No together with a question message such as “preview OK?”. Then, the CPU 5 judges whether any one of the icons Yes and No is determined using the cursor CR to judge whether the AV file generated is acceptable.

When, in step S306, the icon of No is determined and a negative result indicating that the AV file generated is unacceptable is obtained, the CPU 5 returns to step S302 and again performs the processing for selecting a video and a sound that should be combined.

On the other hand, when, in step S306, the icon of Yes is determined and an affirmative result indicating that the AV file generated is acceptable is obtained, in step S307, the CPU 5 generates an AV/text file obtained by synchronizing text data with the AV file.

In other words, the CPU 5 generates a data file obtained by associating the read-out data generated earlier with the AV file generated.

In the subsequent step S308, the CPU 5 performs processing for writing the AV/text file generated in a disk. Specifically, the CPU 5 supplies the AV/text file generated to the disk drive 17 disk drive 17 and instructs the disk drive 17 to write the AV/text file in the optical disk D.

### Second Embodiment

### Explanation of Operations in the Second Embodiment

Operations of the editing system 50 according to the second embodiment will be explained.

The editing system 50 according to the second embodiment performs, as the method of the Voice Over, in a state in which an edited video is obtained, operations applicable to a case in which a narration sound is combined with the video to produce news contents.

Structures of the editing apparatus 2 and the personal computer 3 according to the second embodiment are the same as those in the first embodiment except that contents of the editing apparatus side program 6a and the PC side program 30a stored therein are different. Thus, repeated explanations of the structures are omitted.

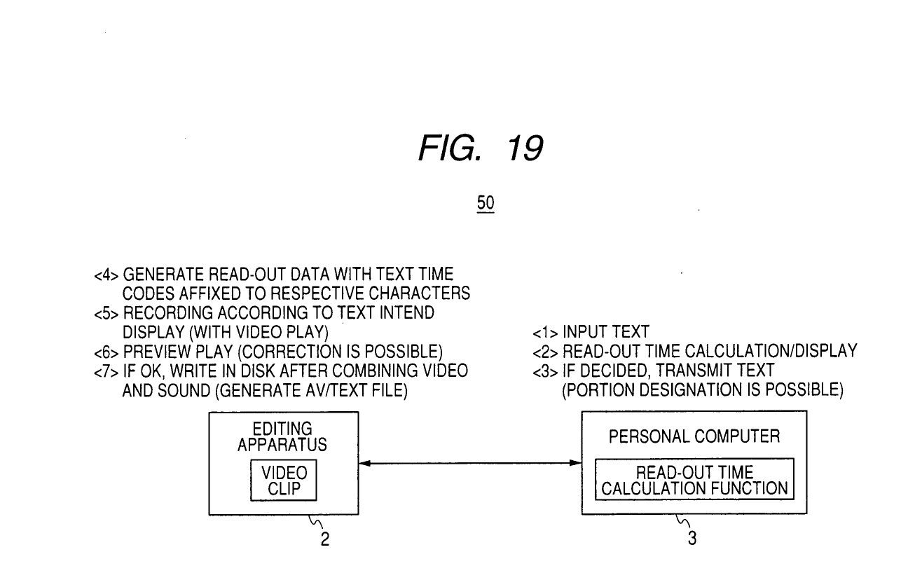

FIG. 19 schematically shows operations performed by the editing system 50 according to the second embodiment.

In the editing system 50 according to the second embodiment, as shown in the figure, an edited video file as a video clip is already present in the editing apparatus 2.

For convenience of explanation, in the figure, the video clip is shown as being stored in the editing apparatus 2. However, actually, as in the first embodiment, the video clip is stored in the optical disk D inserted in the editing apparatus 2. Although only one video clip is shown in the figure, in the following explanation, it is assumed that there are plural video clips (e.g., four video clips A to D described later).

In the second embodiment, as shown in the figure, a read-out time calculation function is given to the personal computer 3 side.

For such a read-out time calculation function on the personal computer 3 side, a program for realizing the read-out time calculation function (and table data in which the numbers of speech words of respective characters are stored) is added as the PC side program 30a. The read-out time calculation function is realized by software processing by the CPU 21.

In FIG. 19, in the editing system 50 according to the second embodiment, as in the first embodiment, a user inputs text data to the personal computer 3 side (<1> in the figure). In this case, as in the first embodiment, the input of the text data is performed after a screen for text input is displayed on the display 27.

When operation for deciding the inputted text data is performed, as indicated by <2> in the figure, calculation a read-out time is performed on the personal computer 3 side. Information on a read-out time length calculated is displayed on the display 27.

By displaying the information on the read-out time length in this way, it is possible to notify the user of the read-out time length. Consequently, the user can judge whether the read-out time length of the inputted text data fits in, for example, a time limit set in advance.

After the information on the read-out time length is displayed in this way, on the personal computer 3 side, it is judged whether predetermined determination operation has been performed. When the inputted text data is decided, the inputted text data is transmitted to the editing apparatus 2 side (<3> in the figure).

In the second embodiment, as an operation applicable to a case in which an edited video clip is already present, which is a method of the Voice Over, it is possible to perform a portion designating operation for reading out a designated text portion at the same time as reproduction of a designated video portion.

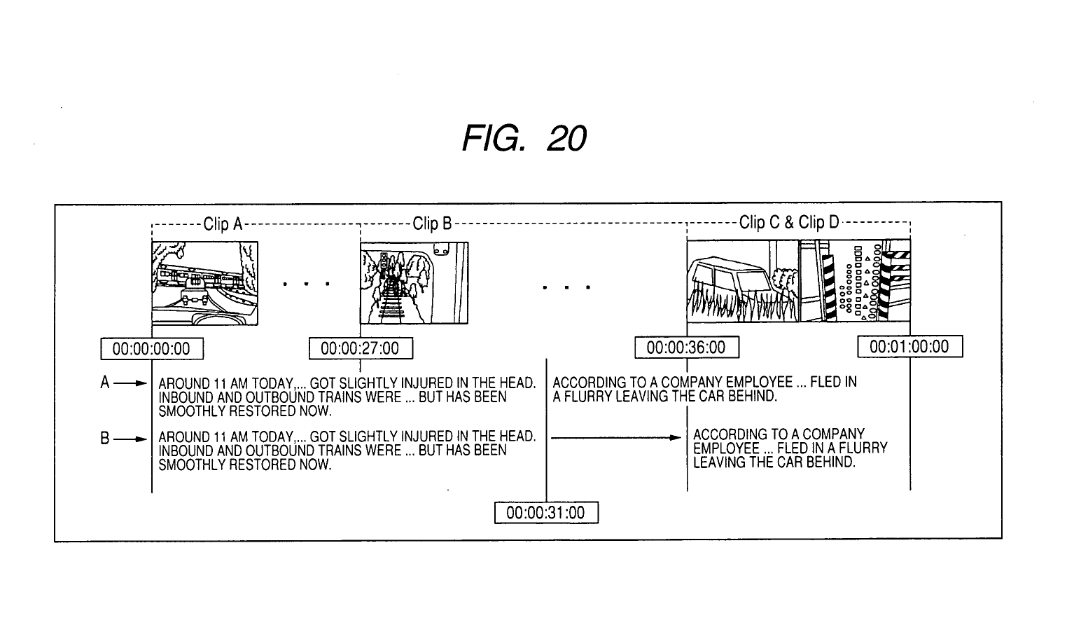

FIG. 20 is a conceptual diagram concerning such portion designating operation in the second embodiment.

In this case, it is assumed that, as shown in the figure, there are, for example, four video clips A, B, C, and D as edited videos that are recorded in the optical disk D in order to overlay narration sounds thereon. In this case, the video clip A is a clip located at the head on a time axis and followed by the video clip B, the video clip C, and the video clip D in this order.

Naturally, an in point (a start point) of the video clip A at the head is “00:00:00:00”. In this case, an out point (an end point) of the video clip A, i.e., an in point of the video clip B is “00:00:27:00” as shown in the figure. Similarly, as shown in the figure, an out point of the video clip B, i.e., an in point of the video clip C is “00:00:36:00” and an out point of the video clip D is “00:01:00:00”.

Here, in points and out points of the respective video clips are indicated by video time codes attached to video data by a unit of frame image. Lower two digits of a time code indicate a frame number (0 to 29), the following two digits indicate a second, the following two digits indicate a minute, and the following two digits indicates an hour. In this case, a time length of a series of video data formed by the video clips A to D is just one minute.

When inputted text data in this case (“Around 11 am today, . . . got slightly injured in the head. Inbound and outbound trains were . . . but has been smoothly restored now. According to a company employee . . . fled in a flurry leaving the car behind.”) is continuously read out at a predetermined read-out speed, as indicated by A in the figure, a read-out endpoint on the time axis is in the video clips C and D. Therefore, a readout time in this case fits in the time length (one minute) of the series of video data, which is set as a time limit length.

The portion designation in the second embodiment is performed for the purpose of reading out, as indicated by B in the figure, a part of the inputted text data (in the example of this figure, a last sentence “According to a company employee . . . fled in a flurry leaving the car behind.”) at the same time as reproduction of a part of the video (in this case, the last video clips C and D).

In other words, the portion designating operation in this case is an operation for designating a necessary portion of the edited video and designating a part of the text data as a narration portion, which should be overlaid on this video portion, such that the designated text portion is read out in the designated video portion.

Referring back to FIG. 19, in performing such portion designation, first, on the personal computer 3 side, an acceptance screen for accepting the portion designation is displayed. Specifically, in the personal computer 3, according to the operation for deciding the inputted text data as explained above, the acceptance screen for accepting such portion designation is displayed on the display 27.

Although not shown in the figure, in this acceptance screen for the portion designation, the icons indicating the items of Yes and No and the cursor CR for selecting the icons are displayed together with a question message such as “designate a portion?”.

The user can move the cursor CR and select the item of Yes or No by performing, for example, mouse operation of the input unit 25 and determine the selected item by performing predetermined operation such as left click operation of the mouse.

When the item of No is selected and determined in this acceptance screen, the personal computer 3 transmits the inputted text data to the editing apparatus 2.

On the editing apparatus 2 side, text time codes is attached to respective characters of the text data transmitted from the personal computer 3 in this way to generate read-out data (<4> in the figure).

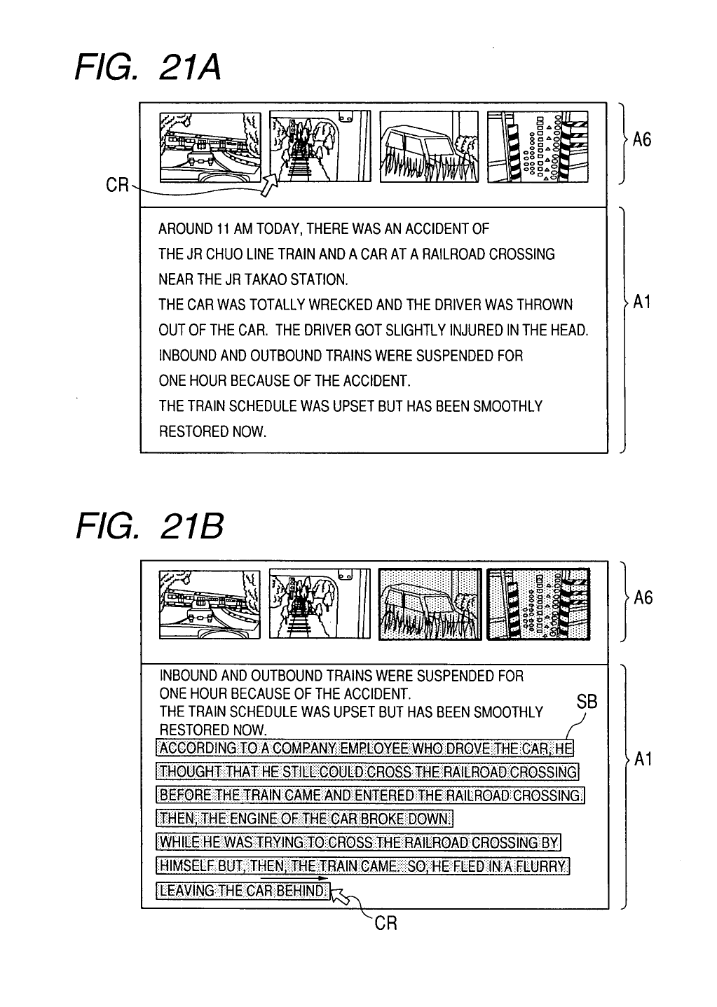

When the item of Yes is selected and determined in the acceptance screen, the personal computer 3 displays a video/text portion designating screen shown in FIG. 21A on the display 27.

In FIG. 21A, in this video/text portion designating screen, as in the sound/video composition screen shown in FIGS. 11A and 11B, the video clip display area A6 for displaying video thumbnail images representing respective video slips of an edited video and the text display area A1 for displaying inputted text data are provided. Moreover, in this video/text portion designating screen, the cursor CR for designating a range of character strings in the text display area A1 and designating the video clips (the video thumbnail images) in the video clip display area A6 is also displayed.

In this case, as in the above case, the user can move the cursor CR by performing mouse operation of the input unit 25. In the text display area A1, for example, by performing operation for moving the house while performing the left click operation of the mouse (so-called drag operation), as shown in FIG. 21B, the user can designate a range of the text data displayed in the text display area A1 using the range designation bar SB. In this case, the user can decide the range designated using the range designation bar SB by stopping the left click operation of the mouse.

The user can select desired video clips shown in the video clip display area A6 by moving the cursor CR to the video clip display area A6 according to the mouse operation. Then, the user can designate the selected video clips by performing predetermined determination operation such as the left click operation of the mouse. In the example in FIG. 21B, as an example corresponding to the case of FIG. 20, the video clip C and the video clip D are designated. In this case, as in the above case, video thumbnail images of the designated video clips are displayed, for example, with a color as shown in the figure to clearly indicate that the video clips are designated.

Consequently, it is possible to designate which text portions are combined with which video portions.

The video clips on which sounds are overlaid are recorded in the optical disk D inserted in the editing apparatus 2 as described above. Thus, in displaying such a video/text portion designating screen, the personal computer 3 needs to have acquired video thumbnail images of the respective video clips from the editing apparatus 2.

Therefore, prior to displaying the video/text portion designating screen, first, the personal computer 3 instructs the editing apparatus 2 side to transmit video thumbnail images of the video clips recorded in the optical disk D.

Referring back to FIG. 19, in the personal computer 3, according to the portion designation of a video and a text by the display of the video/text portion designating screen, designation information for read-out data generation for reading out the designated text portion at the same time as reproduction of the designated video portion is generated.

As described later, in this case, the personal computer 3 transmits the designation information and the text data to the editing apparatus 2 side. In other words, in this case, as it is seen with reference to the operation in <4> explained above, the editing apparatus 2 generates the read-out data itself.

According to the example in FIG. 20, an in point of the designated text portion in this case (“According to a company employee . . . fled in a flurry leaving the car behind.”) is “00:00:31:00”. An in point of the video clips C and D designated as a position where this text portion should be read out is “00:00:36:00”.

In order to read out the designated text portion at the same time as reproduction of the designated video portion, values of text time codes attached to respective characters of the designated text portion only have to be shifted to match an in point of the designated text portion to an in point of the designated video portion. Specifically, in this case, the in point of the designated video portion deviates from the in point of the designated text portion by 5 seconds according to the calculation “00:00:36:00”−“00:00:31:00”=“00:00:05:00”. Thus, by correcting all the values of the text time codes attached to the respective characters of the designated text portion to be increased by 5 seconds, it is possible to shift read-out timing such that the designated text portion is read out at the same time as reproduction of the designated video portion.

In the personal computer 3, a deviation amount (a deviation time) of the in point of the designated video portion with respect to the in point of the designated text portion is calculated in this way to obtain a shift time length of the text time codes that should be attached to the respective characters of the designated text portion. The time length is set as the designation information and this designation information and the inputted text data are transmitted to the editing apparatus 2 side.

On the editing apparatus 2 side, by shifting, on the basis of this designation information, the values of the text time codes that should be attached to the designated text portion, it is possible to generate read-out data for reading out the designated text portion at the same time as reproduction of the designated video portion.

For simplification of explanation, the above explanation is on the premise that a read-out time length of the designated text portion fits in a time length of the designated video portion. However, actually, it is conceivable that a read-out time length of the designated text portion does not fit in a time length of the designated video portion.

Thus, to cope with such a case, in the personal computer 3, correction of the designated text portion is accepted when, as a result of calculating a read-out time length of the designated text portion and a time length of the designated video portion, the read-out time length of the designated text portion does not fit in the time length of the designated video portion.

The correction of the designated text portion is performed by displaying, for example, a screen same as the video/text portion designating screen shown in FIG. 21. Specifically, correction of characters of the designated text portion displayed in the text display area A1 is performed on the screen same as the video/text portion designating screen according to keyboard operation of the input unit 25.

Since the correction of the designated text portion is performed within the time length of the designated video portion, the correction is accepted.

The above explanation is on the premise that a text portion other than the designated text portion fits in a video portion other than the designated video portion. However, depending on a way of designating portions of a video and a text, a situation in which the text does not fit in the video in portions other than the designated portions could occur. For example, in the example in FIG. 20, when only a text portion “fled in a flurry” is designated with respect to the video clips C and D, the designated text portion “fled in a flurry” fits in the designated video portion (the video clips C and D). However, it is likely that a text portion other than the designated text portion does not fit in a video portion (the video clips A and B) other than the designated video portion.

Thus, actually, it is judged whether the text fits in the video in portions other than the designated portions and, if the text does not fit in the video, correction of the text is accepted for the portion other than the designated text portion.

This operation for correcting the text in the portion other than the designated text portion is also performed by displaying a screen same as that during the correction of the designated text portion.

In the above explanation, the portion designation is performed to adjust the last portion of the text to the portion including the last clip of the video. However, for example, in FIG. 20, it is conceivable that designation is performed to adjust portions of a video and a sound to each other, for example, adjust the text portion “Inbound and outbound trains were . . . but has been smoothly restored now.” is adjusted to the video clip B.

Consequently, two video portions not designated (undesignated portions) before and after the video clip A and the video clips C and D of the video are formed. Similarly, two undesignated portions before and after the text portions “Around 11 am today, . . . got slightly injured in the head.” and “According to a company employee . . . fled in a flurry leaving the car behind.” of the text are formed.

In this case, if the text does not fit in the video in a portion before the designated portion (i.e., a time length of the text portion “Around 11 am today, . . . got slightly injured in the head.” does not fit in the time length of the video clip A), it is difficult to read out the designated text portion at the same time as reproduction of the designated video portion.

On the other hand, if the text does not fit in the video in a portion after the designated portion (i.e., a time length of “According to a company employee . . . fled in a flurry leaving the car behind.” does not fit in the time length of the video clips C and D), it is difficult to read out the inputted text within the time limit length (in this case, one minute).

Thus, when the undesignated portions are formed before and after the designated portion, it is judged, concerning the undesignated portions, whether a read-out time length of the text fits in the time length of the video. When the read-out time length of the text does not fit in the time length of the video, correction of the text is accepted. In this case, as in the above case, the correction of the text is accepted until the read-out time length of the text fits in the time length of the video.

In this case, as in the above case, in the portion before the designated portion, when an end point of the text is before an endpoint of the video, designation information for shifting a text time code that should be attached to the following designated text portion by an amount equivalent to a difference between the end points is generated.

This makes it possible to match a read-out start position of the designated text portion and a start position of the designated video portion to each other.

When an end point of the designated text portion is before an end point of the designated video portion, designation information for shifting a text time code that should be attached to a text portion after this designated text portion by an amount equivalent to a difference between the end points is generated.

This makes it possible to match a read-out start position of the text portion after the designated text portion and a start position of a video portion after the designated video portion to each other.

Portion designation may be performed for both the video and the text to adjust head portions thereof to each other. In the example in FIG. 20, portion designation is performed to adjust the text portion “Around 11 am today, . . . got slightly injured in the head.” to the video clip A.

In this case, a difference between an end point of the designated text portion and an end point of the designated video portion is calculated and designation information for shifting a text time code of a text portion after the designated text portion by an amount equivalent to this time length calculated.

Even in this case, when read-out times of the designated text portion and a text portion not designated do not fit in time lengths of video portions corresponding thereto, respectively, correction of the text is accepted in the same manner.

As explained above, the personal computer 3 in this case judges, concerning the designated text portion and the designated video portion and the text portion and the video portion other than the designated portions, whether read-out time lengths of the text fit in the time length of the video, respectively.

In performing such judgment, the personal computer 3 needs to grasp time lengths of the respective video clips recorded in the optical disk D. Therefore, at least prior to performing the judgment of time lengths of the text and the video, the personal computer 3 instructs the editing apparatus 2 side to transmit information on in points and out points of the video clips recorded in the optical disk D.

According to the above explanation, the personal computer 3 in this case causes the editing apparatus 2 side to transmit the video thumbnail images of the respective video clips in displaying the video/text portion designating screen. Thus, the personal computer 3 requests the editing apparatus 2 side to transmit information on the in point and the out points of the respective video clips at timing same as timing of the transmission of the video thumbnail images.

In FIG. 19, when the portion designation is performed on the personal computer 3 side in this way, in the editing apparatus 2, designation information for generation of read-out data for reading out the designated text portion at the same time as reproduction of the designated video portion is received together with the inputted text data. As described above, when the portion designation is not performed, only the inputted text data is received from the personal computer 3 side.

After the generation of the read-out data based on the inputted text data (and the designation information) is performed as the operation in <3>, as in the case of the first embodiment, the recording operation by the text intend display as a recording support operation (<5>) is performed, the preview play (<6>) is performed, and the writing (<7>) of a generated AV file in the optical disk D after combining a video and a sound is performed if the generated AV file is acceptable.

However, in this case, since recording is performed as the Voice Over in a state in which an edited video is already present, as the recording operation by the text intend display in <5>, the edited video is displayed in the sub-screen area A2 of the recording screen indicated by the transition in FIGS. 6 to 8.

Such transition of the recording screen during the recording in the case of the second embodiment is the same as that during the preview play after combining the sound and the video in the case of the first embodiment explained in FIGS. 12 to 14. Thus, a repeated explanation of the transition is omitted.

Since such a recording support operation by the text intend display is performed, it is possible to support the user to easily read out an inputted script within a predetermined time limit.

As explained above, in the case of the second embodiment, the portion designating operation is possible and it is possible to generate read-out data to allow the user to read out a designated text portion at the same time as reproduction of a designated video portion.

In other words, according to the second embodiment in which the record support operation by the text intend display based on the read-out data is performed, it is also possible to support the user such that the user can easily read out the designated text portion at the same time as reproduction of the designated video portion.

As the preview play in <6>, the preview play of the edited video and the recorded sound is performed in association with the Voice Over.

In the preview play in <6>, screen transition itself is also the same as that during the preview play after combining the sound and the video in the case of the first embodiment explained with reference to FIGS. 12 and 14. Thus, a repeated explanation of the screen transition is omitted.

Although an explanation referring to the drawings is omitted, after the preview play in <6>, correction of the recorded sound is accepted. Moreover, in this case, as in the above case, in correcting the recorded sound, as in the case of the first embodiment, it is possible to perform the time axis compression/expansion processing, the re-recording by the portion designation, and the re-recording from the beginning.

Therefore, display forms of a correction acceptance screen, a time axis compression/expansion acceptance screen, and a portion designation acceptance screen that should be displayed on the display unit 15 after the preview play are the same as those shown in FIGS. 9A, 9B, and 9C.

A portion designating screen that should be displayed after Yes is decided in the portion designation acceptance screen (FIG. 9C) is the same as that explained with reference to FIGS. 10A and 10B. Thus, an explanation of the portion designating screen is omitted.

In the case of the Voice Over, synchronous reproduction of the video and the sound is already performed during the preview play after the recording as described above. Thus, when it is judged as a result of the preview play that correction is not performed and the recorded sound is decided, the video and the sound are directly combined according to the operation in <7> to generate an AV file and the AV file is written in the optical disk D.

In this case, as in the above case, by recording the AV file generated in the optical disk D in association with the read-out data, an AV/text file obtained by synchronizing the inputted text data with the vide and the sound is generated.

Consequently, in this case, as in the above case, it is possible to directly use the text data inputted as a news script (a narration script) during the recording as text data for the closed-caption broadcast. It is possible to omit new input of text data for the closed-caption broadcast under the present situation.

[Processing Operations]

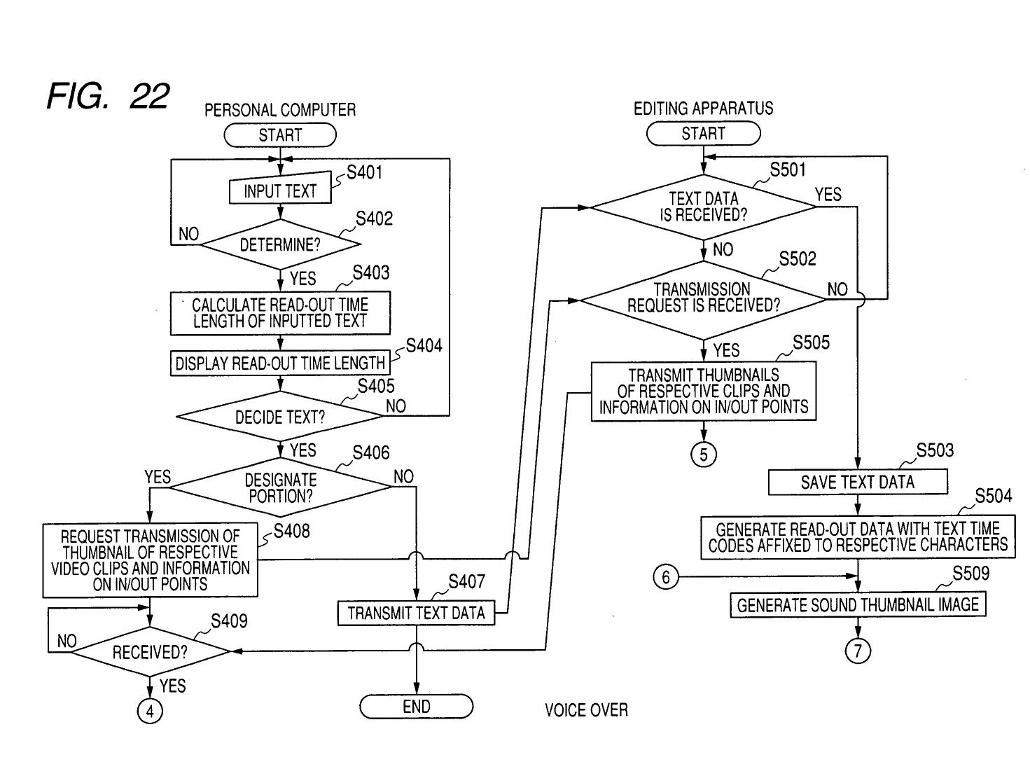

Flowcharts in FIGS. 22 to 25 show processing operations that should be performed in order to realize the operations according to the second embodiment explained above.

In these figures, as in the flowcharts described above, the CPU 5 shown in FIG. 2 executes, on the basis of the editing apparatus side program 6a in the ROM 6, processing operations shown as being performed by the editing apparatus. The CPU 21 executes processing operations processing operation on the personal computer side on the basis of the PC side program 30a stored in the HDD 30.

In FIG. 22, it is assumed that the editing apparatus 2 and the personal computer 3 are already in a state in which data communication is possible.

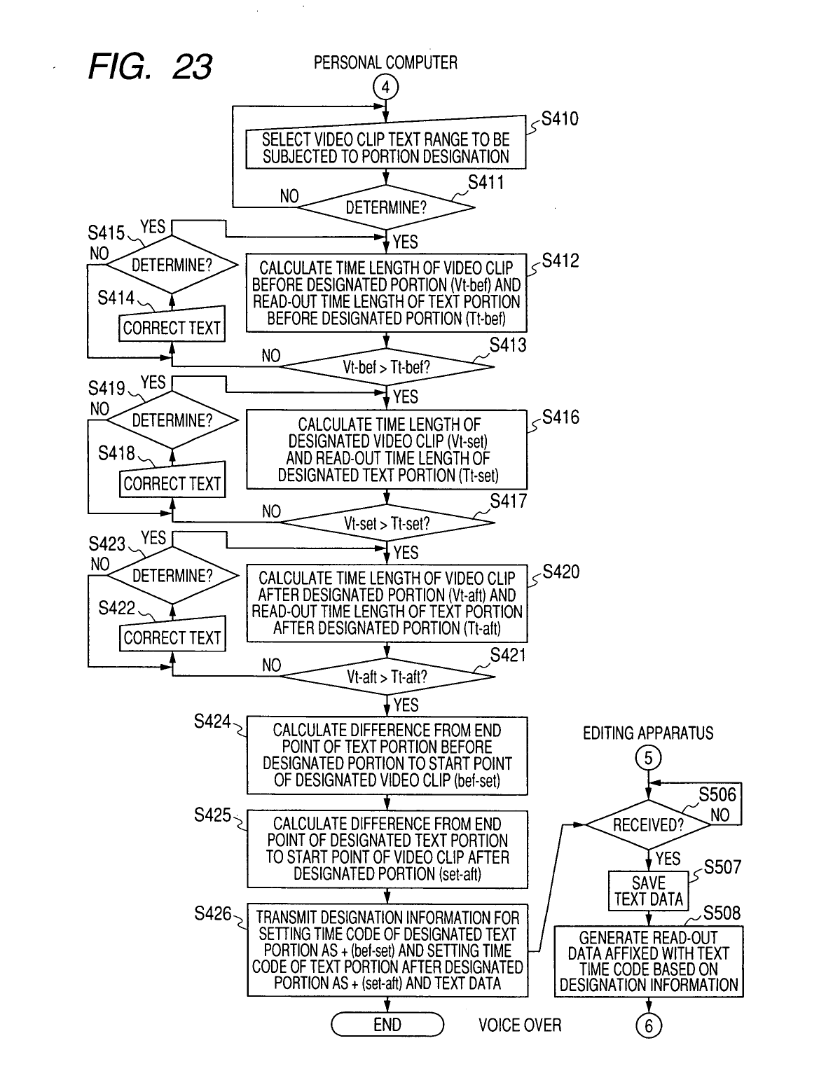

FIGS. 22 and 23 mainly show a processing operation that should be performed in the editing system 50 in association with the time of generation of read-out data from an input of text data.

First, in FIG. 22, in the personal computer 3, the CPU 21 executes processing for inputting a text in step S401 shown in the figure. Specifically, the CPU 21 performs processing for displaying an input screen for text input on the display 27 and displaying text data corresponding to operation of the mouse and the keyboard of the input unit 25 on this screen.

In step S402, the CPU 21 performs processing for judging whether determination operation has been performed. In this case, as in the above case, the determination operation is performed by operating a determination button displayed on the input screen. Specifically, in step S402, the CPU 21 judges whether predetermined operation such as left click operation of the mouse has been performed in a state in which an icon as the determination button displayed on the input screen is selected by a cursor also displayed on the input screen.

In this case, as in the above case, when the determination operation has not been performed, the CPU 21 continuously performs the processing for inputting the text data in step S401 as shown in the figure.

On the other hand, when it is judged that the determination operation is performed and an affirmative result is obtained, the CPU 21 proceeds to step S403 and calculates a read-out time length of the inputted text.

As described above, the calculation of the read-out time length in the case of the second embodiment is performed by the processing by the CPU 21. A calculation method in this case is the same as that in the first embodiment.

In step S404, the CPU 21 executes processing for displaying the read-out time length. Specifically, the CPU 21 supplies information on the read-out time length calculated to the display processing unit 26 and instructs the display processing unit 26 to display the information on the display 27.

In this case, to make it possible to perform judgment on decision of a text explained below, the CPU 21 performs instruction for displaying the icons of Yes and No for inquiring the user whether the text should be decided and a cursor for selecting the icons on the display 27 together with the information on the read-out time length calculated.

In the subsequent step S405, the CPU 21 performs processing for judging whether the text should be decided.

The CPU 21 performs the processing in step S405 by judging which of the icons of Yes and No displayed together with the information on the read-out time length on the display 27 as described above is selected and determined.

When the predetermined operation such as the left click operation of the mouse is performed in a state in which the icon of No displayed on the display 27 is selected using the cursor and a negative result is obtained, as shown in the figure, the CPU 21 returns to step S401 and executes the text input processing again.

Since it is possible to correct the inputted text after calculation and display of the read-out time length in this way, as described above, the user can correct the text when the displayed read-out time length exceeds a predetermined time limit length.

On the other hand, when the predetermined operation such as the left click operation of the mouse is performed in a state in which the icon of Yes is selected using the cursor and an affirmative result is obtained, the CPU 21 proceeds to step S406 and performs processing for judging whether portion designation is performed.

As explained above, in performing the portion designation, first, the CPU 21 displays an acceptance screen for accepting the portion designation. Specifically, in step S406, first, the CPU 21 displays such an acceptance screen (including a question message such as “designate a portion?”, the icons of Yes and No, and the cursor CR as described above) on the display 27. Then, the CPU 21 judges which of the items of Yes and No is selected and determined using the cursor CR.

When, in step S406, the predetermined determination operation such as the left click operation of the mouse is performed in a state in which the icon of No is selected using the cursor CR and a negative result indicating that the portion designation is not performed, the CPU 21 proceeds to step S407 and executes processing for transmitting the text data to the editing apparatus 2. Specifically, the CPU 21 controls the USB interface 23 to transmit the text data decided as described above to the editing apparatus 2 connected to the personal computer 3 via the USB terminal Tusb.

When the processing in step S407 is executed, as shown in the figure, the processing operation is finished.

On the other hand, when, in step S406, the predetermined operation such as the left click operation of the mouse is performed in a state in which the icon of Yes is selected using the cursor CR and an affirmative result indicating that the portion designation is performed, the CPU 21 proceeds to step S408 and requests the editing apparatus 2 to transmit thumbnails of respective video clips and information on in and out points. Specifically, in performing a portion designating operation, in order to display the video/text portion designating screen shown in FIG. 21, the CPU 21 requests video thumbnail images of the respective video clips recorded in the optical disk D. At the same time, the CPU 21 also requests transmission of information on in and out points of the respective video clips for judging whether a text read-out time fits in a time length of a video.

On the editing apparatus 2 side, the CPU 5 stands by for reception of one of the text data and the transmission request from the personal computer 3 in processing in steps S501 and S502 shown in the figure.

First, when, in step S501, it is judged that the text data from the personal computer 3 is received and an affirmative result is obtained, the CPU 5 proceeds to step S503. After saving (recording) the text data in the nonvolatile memory 8, in the following step S504, the CPU 5 executes processing for generating read-out data with text time codes attached to respective characters. Specifically, the CPU 5 supplies the text data saved to the read-out time calculating/read-out data generating unit 16 and causes the read-out time calculating/read-out data generating unit 16 to generate read-out data. In this case, as in the above case, the CPU 5 records the read-out data generated in this way in, for example, the nonvolatile memory 8.

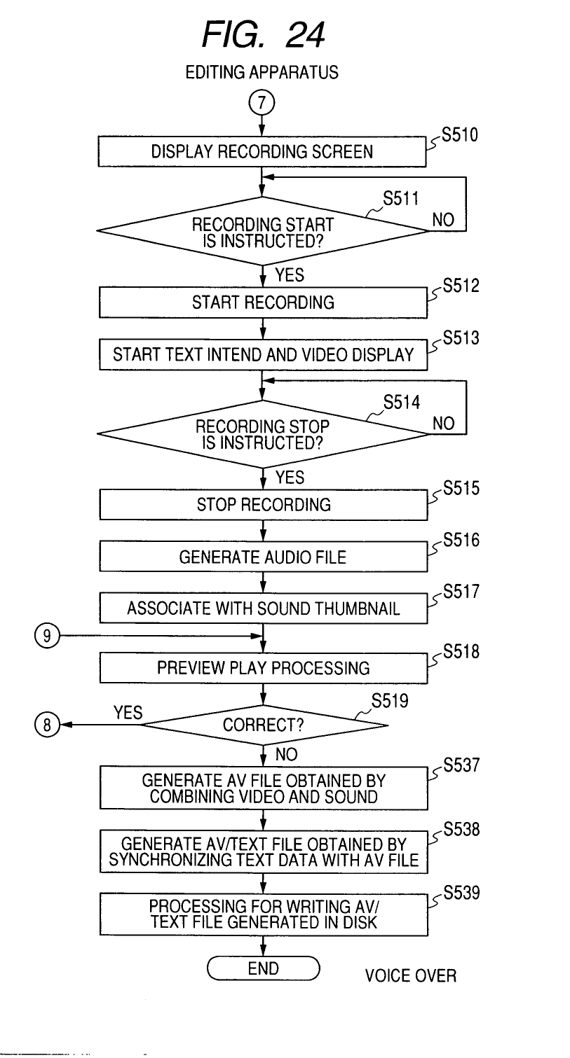

In the next step S509, the CPU 5 generates a sound thumbnail image. After executing processing in step S509, the CPU 5 advances the processing to step S510 in FIG. 24 described later.

On the other hand, when, in step S502, it is judged that the transmission request from the personal computer 3 is received and an affirmative result is obtained, the CPU 5 proceeds to step S505 and executes processing for transmitting the thumbnails of the respective video clips and the information on the in and out points to the personal computer 3.

As the processing in step S505, first, the CPU 5 causes the disk drive 17 to reproduce video data, which are the respective video clips recorded in the optical disk D, and obtains predetermined frame image data (in this case, as in the above case, for example, frame image data a the head) of the respective video data, which are obtained by the reproduction, as video thumbnail images. In this case, the CPU 5 also obtains video time codes recorded to be attached to the respective video clips in the optical disk D and obtains the information on the in and out points of the respective video clips on the basis of the video time codes. Then, the CPU 5 controls the USB interface 12 to transmit the video thumbnail images of the respective video clips and the information on the in and out points obtained in this way to the personal computer 3.

After executing the processing in step S505, the CPU 5 advances the processing to step S506 in FIG. 23.

On the personal computer 3 side, in step S409, the CPU 21 stands by for reception of the video thumbnail images of the respective video clips and the information on the in and out points from the editing apparatus 2.

When these kinds of information are received, the CPU 21 proceeds to step pS410 shown in FIG. 23.

FIG. 23 shows a processing operation that should be performed in association with the time of the portion designating operation explained above.

First, on the personal computer 3 side, in step S410 shown in the figure, the CPU 21 executes processing for selecting a video clip and a text range to be subjected to portion designation. Specifically, first, the CPU 21 supplies the respective video thumbnail images received and the inputted text data decided to the display processing unit 26 and controls the display processing unit 26 to display the video/text portion designating screen shown in FIG. 21A on the display 27.

Then, according to operation via the input unit 25, the CPU 21 controls the display control unit 26 to clearly indicate selected video thumbnail images and text range on the video/text portion designating screen, display the selected video thumbnail images with a color, and display the range designation bar SB in the selected text range.

In step S411, the CPU 21 performs processing for judging whether determination operation has been performed. In this case, the determination of the portion designation is performed when designation of the text range is completed after designation of the video clips is performed on the video/text portion designating screen. Therefore, in step S411, the CPU 21 judges whether operation for completing designation of the text range (in this case, finish of the left click operation of the mouse as finish of the drag operation) has been performed.

When it is judged that the determination operation has not been performed and a negative result is obtained as a result of the judgment in step S411, the CPU 21 continues to perform the processing in step S410 and accepts the operation for designating video clips and a text range to be subjected to portion designation.

When it is judged that the determination operation has been performed and an affirmative result is obtained, the CPU 21 proceeds to step S412.

In step S412, the CPU 21 calculates a time length (Vt-bef) of video clips before a designated portion and a read-out time length (Tt-bef) of a text portion before a designated portion.

Specifically, the CPU 21 calculates the time length (Vt-bef) of video clips before the video clips designated in steps S410 and S411 on the time axis among the respective video clips indicated by the video thumbnail images on the video/text portion designating screen and the read-out time length (Tt-bef) for a text portion before the text portion designated in steps S410 and S411 among the text data shown on the video/text portion designating screen.

In this case, the CPU 21 can calculate the time length (Vt-bef) of the video clips before the designated portion on the basis of the information on the in and out points of the respective video clips received in step S409.

In the subsequent step S413, the CPU 21 performs processing for judging whether vt-bef is larger than vt-bef. Specifically, the CPU 21 judges whether the read-out time length (Tt-bef) of the text portion before the designated portion fits in the time length (Vt-bef) of the video clips before the designated portion.

When, in step S413, it is judged that Vt-bef is not larger than Tt-bef and a negative result is obtained, the CPU 21 proceeds to step S414 and performs text correction processing.

As described above, the CPU 21 performs the correction in this case by displaying a screen same as the video/text portion designating screen shown in FIG. 12. Specifically, in step S414, the CUP 21 performs processing for displaying the screen same as the video/text portion designating screen on the display 27 and, then, according to keyboard operation of the input unit 25, updating display of text data displayed in the text display area A1.

In the subsequent step S415, the CPU 21 judges whether determination operation has been performed. Specifically, the CPU 21 judges whether operation for deciding a corrected text has been performed.

In this case, decision of the corrected text is performed according to predetermined operation via the input unit 25. In step S415, the CPU 21 judges whether such predetermined operation has been performed.

When it is judged that the determination operation has not been performed and a negative result is obtained, the CPU 21 executes the processing in step S414 and continues to accept correction of the text.

When it is judged that the determination operation has been performed and an affirmative result is obtained, the CPU 21 returns to step S412 as shown in the figure. Consequently, a read-out time length is calculated again for the text after the correction and, in step S413 after that, the processing for judging whether Vt-bef is larger than Tt-bef is performed again. In other words, according to the series of processing in steps S412, S413, S414, and S415, it is possible to correct the text until Tt-bef fits in Vt-bef.

When, in step S413, it is judged that Vt-bef is larger than Tt-bef and an affirmative result is obtained, the CPU 21 proceeds to step S416 and calculates a time length (Vt-set) of the designated video clips and a read-out time length (Tt-set) of the designated text portion.

In the following step S417, the CPU 21 performs processing for judging whether Vt-set is larger than Vt-set and judges whether the read-out time length (Tt-bef) of the designated text portion fits in the time length (Vt-set) of the designated video clips.

When it is judged that Vt-set is not larger than Tt-set and a negative result is obtained, in this case, as in the above case, processing for correcting the relevant text portion (steps S418 and S419) is executed. Consequently, it is also possible to correct the designated text portion until the read-out time length thereof fits in the time length of the video clips corresponding thereto.

When, in step S417, it is judged that Vt-set is larger than Tt-set and an affirmative result is obtained, the CPU 21 proceeds to step S420 and calculates a time length (Vt-aft) of video clips after the designated portion and a read-out time length (Tf-aft) of a text portion after the designated portion.

In the subsequent step S421, the CPU 21 performs processing for judging whether Vt-aft is larger than Tf-aft.

When it is judged that Vt-aft is not larger than Tt-aft and a negative result is obtained, in this case, as in the above case, processing for correction of the relevant text portion (steps S422 and S423) is executed. Consequently, it is also possible to correct the text portion after the designated portion until the read-out time length thereof fits in the time length of the video clips corresponding thereto.

When, in step S421, it is judged that Vt-aft is larger than Tt-aft and an affirmative result is obtained, the CPU 21 proceeds to step S424.

In step S424, the CPU 21 calculates a time length (bef-set) of a difference between an end point of the text portion before the designated portion and a start point of the designated video clip. Specifically, the CPU 21 calculates a read-out finish time of the text portion before the designated text portion, acquires a time of the start point (an inpoint) of the designated video clip from the information on the in and output points acquired earlier, and calculates a difference between the times.

The start point of the designated video clip is the same as an end point of a video clip before the designated video clip. Therefore, it is also possible to perform the calculation processing in step S424 on the basis of the end point (an out point) of the video clip before the designated video clip.

In the subsequent step S425, the CPU 21 calculates a time length (set-aft) of a difference between the end point of the text portion designated and a start point of the video clips after the designated portion. Specifically, the CPU 21 calculates a read-out finish time of the designated text portion, acquires a time of an in point of a (next) video clip after the designated video clip (or an end point of the designated video clip), and calculates a difference between the times.

Then, in the next step S426, the CPU 21 executes processing for transmitting designation information for setting a time code of the designated text portion as +(bef-set) and setting a time code of the text portion after the designated portion as +(set-aft) and the text data to the editing apparatus 2.

Specifically, first, the CPU 21 generates designation information for setting values of text time codes that should be attached to respective characters of the designated text portion as +(bef-set) and setting values of text time codes that should be attached to respective characters of the text portion after the designated text portion as +(set-aft). Then, the CPU 21 controls the USB interface 23 to transmit the designation information and the text data (the text data after the correction when the correction is performed in steps S414, S418, and S422) to the editing apparatus 2.

On the editing apparatus 2 side, in step S506, the CPU 5 stands by for reception of the designation information and the text data. Just for confirmation, in step S506, the CPU 5 performs processing performed after the thumbnails of the respective video clips and the information on the in and out points are transmitted in step S505 in FIG. 2.

When the designation information and the text data are received, in step S507, the CPU 5 saves the text data in the nonvolatile memory 8. In the following step S508, the CPU 5 executes processing for generating read-out data with a text time code based on the designation information attached. Specifically, the CPU 5 supplies the text data saved and the designation information received to the read-out time calculating/read-out data generating unit 16 and causes the read-out time calculating/read-out data generating unit 16 to generate read-out data with a value of the text time code shifted on the basis of the designation information.

The CPU 5 saves the read-out data obtained by the generation in, for example, the nonvolatile memory 8.

After executing the processing in step S508, the CPU 5 proceeds to step S509 in FIG. 22 and generates a sound thumbnail image. As described above, after executing the processing in step S509, the CPU 5 advances the processing to step S510 shown in FIG. 24.

FIG. 24 mainly shows a processing operation that should be executed in the editing apparatus 2 in association with operations from a recording support operation by the text intend display to an operation for writing a combined file of a video and a sound in a disk.

In FIG. 24, first, in step S510, the CPU 5 performs processing for displaying a recording screen. As described above, as the recording screen in this case, the CPU 5 displays a screen (see FIG. 5) having the same structure as that in the first embodiment. However, as described above, in the case of the Voice Over in the second embodiment, the sub-screen area A2 should be a video display area rather than a display area for a sound thumbnail image. Therefore, in the sub-screen area A2 in the recording screen before start of recording, for example, a frame image at the head of the video clips recorded in the optical disk D is displayed. Alternatively, a no-display state (e.g., a full-black image) may be displayed.

In the subsequent step S511, the CPU 5 stands by for a recording start instruction. When the recording start instruction is received, the CPU 5 performs processing for start of recording in step S512. As the processing in steps S511 and S512, processing same as that in steps S212 and S213 shown in FIG. 16 only has to be performed.

In the subsequent steps S513, the CPU 5 performs processing for starting text intend and video display.

Specifically, in step S513, the CPU 5 performs processing same as that in step S214 in FIG. 16 and starts an operation for intend-displaying character strings displayed in the text display area A1 on the recording screen using the intend bar IB. At the same time, the CPU 5 controls the disk drive 17 to sequentially reproduce the video clips recorded in the optical disk D, supplies video data obtained by the reproduction to the character generator 13, and instructs the character generator 13 to display a video of the video clips in the sub-screen area A2 on the recording screen.

As processing from the next step S514 to step S519 (i.e., processing corresponding to operations from stop of recording to correction of a recorded sound after preview play), the CPU 5 performs processing same as that in step S215 to S220 in FIG. 16.

However, as the preview play processing after recording in this case (S518), video display is performed in the sub-screen area A2 as in the case of the recording screen. Thus, processing for sequentially reproducing the respective video clips recorded in the optical disk D and displaying the video clips in the sub-screen area A2 is added.

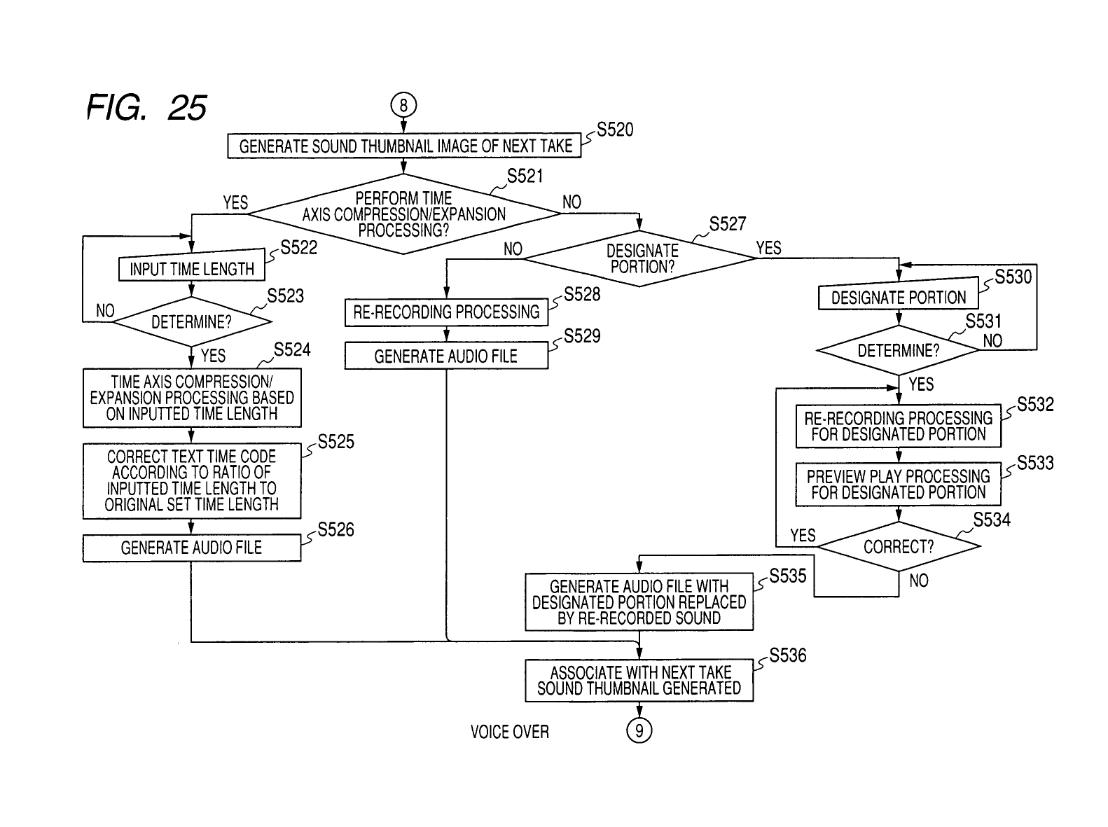

In the second embodiment, after the preview play after recording, the CPU 5 accepts correction of the recorded sound (S519). As sound correction processing in this case, as shown in FIG. 25, the CPU 5 performs processing same as the processing in the case of the first embodiment shown in FIG. 17. In this case, the CPU 5 starts the processing for sound correction in FIG. 25 by shifting to step S520 in FIG. 25 when it is judged that correction is performed and an affirmative result is obtained in step S519 in FIG. 24. In the processing in FIG. 25, after a audio file obtained by correction in step S536 and a sound thumbnail in the next take are associated, the CPU 5 shifts to step S518 shown in FIG. 24 and performs the preview play.

In FIG. 24, when a negative result indicating that correction is not performed is obtained by the judgment processing in step S519, the CPU 5 proceeds to step S537 and executes processing for generating an AV file obtained by combining a video and a sound. Specifically, the CPU 5 controls the signal processing unit 4 to combine video data, which are the respective video clips recorded in the optical disk D, and audio data, which is a recorded audio file.

After generating the AV file in this way, in the next step S538, the CPU 5 generates an AV/text file obtained by synchronizing the text data with the AV file. In the following step S539, the CPU 5 executes processing for writing the AV/text file in the disk. The processing in steps S538 and S539 is the same as that in steps S307 and S308 in FIG. 18.

<Modification>

The embodiments have been explained. However, the invention is not limited to the embodiments explained above.

As an example of the intend display of a text, the intend bar displayed to be superimposed on characters is sequentially extended at timing based on text time codes. Besides, it is also possible to adopt other display forms for, for example, sequentially displaying characters that should be read out in different colors or displaying only characters that should be read out in a size different from other characters.

The intend display in the invention may adopt any display forms as long as it is possible indicate positions of characters that should be read out. A specific display form of the intend display is not limited.

In the embodiments, the intend display is continuously performed without being stopped. However, it is also possible to adopt a display form for, for example, stopping the intend display for a predetermined time length in portions of punctuation.

In performing the intend display, the CPU 5 sequentially informs the character generator 13 of positions of characters that should be intended at present on the basis of read-out data. However, instead, it is also possible that the CPU 5 supplies the read-out data to the character generator 13 and the character generator 13 independently performs intend display processing in accordance with text time codes of the read-out data.

In the embodiments, as an operation coping with the case in which all inputted text data are not fully displayed on the recording screen displayed in association with the time of recording of a narration sound, displayed characters are sequentially scrolled. However, instead, it is also possible to display, for example, when the intend display reaches the last character displayed, the following character strings to replace a displayed character string as much as possible.

In the embodiments, display of the recording screen is automatically performed at necessary timing after input text data is decided and read-out data corresponding to the input text data is generated. However, instead, it is also possible to display the recording screen according to, for example, predetermined operation for instruction of recording standby.

In the embodiments, in a display state of the recording screen, recording and text intend display are immediately started according to a recording start instruction. However, it is also possible to perform countdown display for a predetermined time length on the sub-screen area A2 or the like according to the recording start instruction and start the recording operation and the text intend display after the countdown display is finished.

In particular, in performing re-recording of a designated portion as correction of a recorded sound, with a predetermined number of character strings before the designated portion set as a margin portion, it is possible to perform the intend display from this margin portion like a run-up and start recording when the intend display reaches the designated portion.

When such re-recording is performed, an original recorded sound and a re-recorded sound may have different sound levels. Thus, to cope with such a case, in replacing original audio data with a re-recorded portion, it is also possible to allow the user to perform adjustment of a sound gain.

In the embodiments, a recorded sound is recorded in the nonvolatile memory 8 built in the editing apparatus 2. However, it is also possible to record the recorded sound in the optical disk D.

When a recording medium such as an HDD is separately provided other than the nonvolatile memory 8, the recorded sound may be recorded in the recording medium.

In the embodiments, calculation of a read-out time length is performed after decision of input text data. However, it is also possible to sequentially calculate read-out time lengths for a character range inputted during input of the text data on a real time basis and sequentially display information on the read-out time lengths obtained sequentially.

A method of calculating a read-out time length is not limited to the method described as the example in the embodiments and it is also possible to adopt other methods. For example, a table in which the number of speech words is stored for each plurality of characters such as each word or each phrase rather than for each character is prepared. It is also possible to calculate a read-out time length of inputted text data on the basis of information of this table and a coefficient of a read-out speed.

Alternatively, it is also possible to calculate a read-out time length by using a table in which the read-out time length is directly stored for each character, word, or phrase.

A text time code is attached to each character. However, it is also possible to attach the text time code to each plurality of characters.

In the embodiments, the editing apparatus 2 is capable of recording data in and reading the data out of the optical disk D. The editing apparatus 2 reads out an edited video to be a combination object from the optical disk D and writes (writes back) an AV file finally generated in the optical disk D. However, it is also possible to constitute the editing apparatus 2 to be applicable to other recording media such as a magnetic tape medium and read out the edited video from and write the AV file in recording media other than the optical disk D.

In the example described in the embodiments, an apparatus that accepts a text input is the personal computer 3. However, the apparatus may be any other electronic apparatus as long as the electronic apparatus is capable of accepting a text input and includes a necessary interface that makes it possible to perform data communication with an external apparatus (in this case, the editing apparatus 2).

In the embodiments, a text input is accepted on the personal computer 3 side and, on the editing apparatus 2 side, read-out data is generated for inputted text data from the personal computer 3. However, for example, when a keyboard is provided as an operator on the editing apparatus 2 side, it is also possible to accept a text input on the editing apparatus 2 side and realize all the operations of the editing systems 1 and 50 with the editing apparatus 2 alone.

Conversely, it is also possible to perform all the operations of the editing systems 1 and 50 on the personal computer 3 side. In this case, the read-out time calculating/read-out data generating unit 16 and the signal processing unit 4 (for recording an external sound and combining a video and a sound) constituted by hardware on the editing apparatus 2 side only have to be realized by software processing by the CPU 21.

In this case, respective video clips, which form an edited video, are recorded in, for example, the HDD 30 on the personal computer 3 side. It is possible to combine the video clips and a recorded sound.

For example, when the personal computer 3 side has a read-out time calculation function and a read-out data generation function, it is also possible that operations from calculation of a read-out time of inputted text data to generation of read-out data based on the inputted text data are performed on the personal computer 3 side and the editing apparatus 2 performs a recording operation by text intend display and combination of a recorded sound and an edited video on the basis of the read-out data generated on the personal computer 3 side.

In realizing the operations of the editing systems 1 and 50 explained in the embodiments, a component of the system may be a single apparatus or may be plural apparatuses. However, it is possible to realize the recording system of the invention with any one of the single apparatus or the plural apparatuses as long as the single apparatus or the plural apparatuses include text inputting means for inputting text data, read-out time calculating means for calculating a read-out time length for text data on the basis of information on a predetermined read-out speed, read-out data generating means for generating, on the basis of the information on the predetermined read-out speed, a text time code indicating read-out timing for each predetermined number of characters in the text data and generating read-out data obtained by attaching this text time code to the text data, and controlling means for controlling, according to an instruction, audio data based on an input sound to be recorded in a recording medium and controlling, on the basis of the read-out data, characters based on the text data displayed on a display unit to be intend-displayed.

Just for confirmation, in the case of the first embodiment, the text inputting means is realized by the input unit 25 on the personal computer 3 side. The read-out time calculating means and the read-out data generating means are realized by the read-out time calculating/read-out data generating unit 16 provided in the editing apparatus 2. The controlling means is realized by the CPU 5 of the editing apparatus 2.

In the case of the second embodiment, as in the first embodiment, the text inputting means is realized by the inputting unit 25 on the personal computer 3 side. However, the read-out time calculating means is realized by software processing by the CPU 21 of the personal computer 3.

As in the first embodiment, the read-out data generating means is realized by the read-out time calculating/read-out data generating unit 16 provided in the editing apparatus 2. The controlling means is realized by the CPU 5 of the editing apparatus 2.

In the example described in the embodiments, the text intend display is performed on the display unit provided in the editing apparatus 2. However, for example, when a display device is provided separately, it is also possible to perform the text intend display on the display device. In that case, the editing apparatus 2 only has to be capable of supplying an output of the character generator 13 to the display apparatus on the outside as well.

In the example described in the embodiments, the text inputting means according to the embodiments inputs text data on the basis of an operation input. Besides, it is also possible to recognize an input sound, convert the input sound into text data, and input the text data. For example, when input of the text data is performed according to the sound recognition, it is possible to correct a deficient portion of the text data according to re-recording of the input sound.

As a method of inputting text data, besides the method based on an operation input, it is also possible to read out text data recorded in a necessary recording medium to input the text data.

In the example described in the embodiments, the video clips are formed by only the video data. However, the video clips may include audio data synchronizing with the video clips (e.g., when sounds on the scene are recorded simultaneously with photographing).

In such a case, as processing for combining the video clips and the recorded sound (an audio file recorded by the recording support operation), processing for combining (mixing) the recorded sound with the sounds included in the video clips to synchronize with the video clips only has to be performed.

It should be understood by those skilled in the art that various modifications, combinations, sub-combinations, and alterations may occur depending on design requirements and other factors insofar as they are within the scope of the appended claims or the equivalents thereof.

What is claimed is:

1. A recording system comprising:
an input unit that inputs text data;
a read-out time calculating unit that calculates a read-out time length for text data on the basis of information on a predetermined read-out speed;
a read-out data generating unit that generates, on the basis of the information on the predetermined read-out speed, a text time code indicating read-out timing for each predetermined number of characters in the text data and generates read-out data obtained by attaching this text time code to the text data; and
a control unit that controls, according to an instruction, audio data based on an input sound to be recorded in a recording medium and controls, on the basis of the read-out data, characters based on the text data displayed on a display unit to be intend-displayed.

2. A recording system according to claim 1, further comprising a judging unit that judges whether the read-out time length calculated by the read-out time calculating unit is within a time limit length inputted in advance.

3. A recording system according to claim 1, further comprising a display control unit that controls information on the read-out time length calculated by the read-out time calculating unit to be displayed on the display unit.

4. A recording system according to claim 1, further comprising:
a video/text accepting unit that accepts designation of a part of video data recorded in the recording medium and designation of a part of the text data; and
a correcting unit that corrects a value of the text time code, which should be attached to the text data, such that intend display of a head character in the text data portion designated is started at start timing of the video data portion designated.

5. A recording system according to claim 1, further comprising:
a combining unit that combines audio data and video data recorded in the recording medium; and
a recording control unit that controls the read-out data to be recorded in association with the video and audio data combined by the combining unit.

6. A recording method comprising the steps of:
inputting text data;
calculating a read-out time length for text data on the basis of information on a predetermined read-out speed;
generating, on the basis of the information on the predetermined read-out speed, a text time code indicating read-out timing for each predetermined number of characters in the text data and generating read-out data obtained by attaching this text time code to the text data; and
controlling, according to an instruction, audio data based on an input sound to be recorded in a recording medium and controlling, on the basis of the read-out data, characters based on the text data displayed on a display unit to be intend-displayed.
